(19) United States
(12) Patent Application Publication
(10) Pub. No.: US 2025/0256934 A1
(43) Pub. Date: Aug. 14, 2025

(54) MEDIUM DISCHARGE DEVICE AND ELECTRONIC APPARATUS

(71) Applicant: SEIKO EPSON CORPORATION, Tokyo (JP)

(72) Inventor: Yoichiro NISHIMURA, KITAKYUSHU-SHI (JP)

(21) Appl. No.: 19/051,815

(22) Filed: Feb. 12, 2025

(30) Foreign Application Priority Data
Feb. 14, 2024 (JP) 2024-020071
Jun. 4, 2024 (JP) 2024-090500

(51) Int. Cl. B65H 29/14; B65H 29/54; H04N 1/00; H04N 1/12

(52) U.S. Cl. CPC B65H 29/14; B65H 29/54; H04N 1/00631; B65H 2301/44318; B65H 2404/563; B65H 2801/39; H04N 1/1215; H04N 2201/0081

(57) ABSTRACT

A medium discharge unit includes a discharge roller pair configured to nip a medium between a first roller and a second roller and discharge the medium to a sheet ejection unit, a first pressing member including a medium pressing portion configured to move below a nipping position at which the discharge roller pair nips the medium and being configured to press the medium by the medium pressing portion, and a lifting member configured to lift up the medium pressing portion from a first position below the nipping position to a second position above the first position. The medium pressing portion is lifted by the lifting member while a downstream leading edge of the medium in a discharge direction passes through the nipping position, and moves from the first position to the second position. While an upstream trailing edge of the medium in the discharge direction passes through the nipping position, the medium pressing portion moves from the second position to the first position.

The present application is based on, and claims priority from JP Application Serial Number 2024-020071, filed Feb. 14, 2024, and 2024-090500, filed Jun. 4, 2024, the disclosures of which are hereby incorporated by reference herein in its entirety.

### BACKGROUND

### 1. Technical Field

The present disclosure relates to a medium discharge device and an electronic apparatus.

### 2. Related Art

JP-A-2013-60241 describes a sheet discharge device that discharges a sheet from a pair of sheet ejection rollers to a sheet stack. The sheet discharge device includes first and second sheet pressing members, which can swing interlockingly with each other, downstream of the sheet ejection roller pair in a discharge direction. The first sheet pressing member includes a swinging end that presses a sheet to prevent a trailing edge of a discharged sheet from remaining at the sheet ejection roller pair. The second sheet pressing member has a swinging radius smaller than that of the first sheet pressing member, and includes a swinging end positioned upward of the swinging end of the first sheet pressing member. The sheet discharged from the sheet ejection roller pair contact with the swinging end of the second sheet pressing member, and then is guided to the sheet stack positioned below. Further, when the trailing edge of the sheet passes through the sheet ejection roller pair, the trailing edge of the sheet is pressed down toward the sheet stack by the first sheet pressing member. According to this configuration, the leading edge of the sheet does not contact the first sheet pressing member, and hence the first sheet pressing member can be prevented from excessively pressing down the leading edge of the sheet onto the sheet stack. As a result, hindrance to movement of a sheet due to frictional resistance can be suppressed.

However, in a configuration in which the leading edge of the sheet is pressed by the second sheet pressing member, when rigidity of the sheet is low or the like, the second sheet pressing member may significantly press down the edges in a sheet width direction intersecting with the discharge direction. In this case, sheets on the sheet stack may possibly be disorganized.

### SUMMARY

A medium discharge device is a medium discharge device configured to discharge a medium to a placement unit on which the medium is placed, the medium discharge device including a roller pair including a first roller and a second roller positioned above the first roller and being configured to nip the medium between the first roller and the second roller and discharge the medium to the placement unit, a first pressing member including a first member and being configured to press the medium by the first member, the first member being configured to move below a nipping position at which the roller pair nips the medium, and a lifting member configured to lift up the first member from a first position below the nipping position to a second position above the first position, wherein
the first member is lifted up by the lifting member while a downstream leading edge of the medium in a discharge direction passes through the nipping position, and moves from the first position to the second position, and while an upstream trailing edge of the medium in the discharge direction passes through the nipping position, the first member moves from the second position to the first position.

A medium discharge device is a medium discharge device configured to discharge a medium to a placement unit on which the medium is placed, the medium discharge device including a roller pair including a first roller and a second roller positioned above the first roller and being configured to nip the medium between the first roller and the second roller and discharge the medium to the placement unit, and a discharge assisting member configured to assist a discharge operation of the medium to be discharged from the roller pair, wherein the discharge assisting member includes a medium pressing portion configured to move between a first position below a nipping position at which the roller pair nips the medium and a second position above the first position and press down the medium in the process of moving from the second position to the first position, and a medium abutting portion against which the medium abuts upstream of the medium pressing portion in the discharge direction of the medium, when the medium abuts against the medium abutting portion while a downstream leading edge of the medium in the discharge direction passes through the nipping position, the medium pressing portion moves from the first position to the second position, and when the medium abutting portion is separated from the medium while an upstream trailing edge of the medium in the discharge direction passes through the nipping position, the medium pressing portion moves from the second position to the first position.

An electronic apparatus includes the medium discharge device described above.

### BRIEF DESCRIPTION OF THE DRAWINGS

FIG. 1 is a perspective view illustrating a schematic configuration of an image reading apparatus.

FIG. 2 is a cross-sectional view illustrating an internal configuration of the image reading apparatus.

FIG. 3 is a side view illustrating a configuration of a medium discharge unit of a first embodiment.

FIG. 4 is a plan view illustrating a configuration of the medium discharge unit of the first embodiment.

FIG. 5 is a side view illustrating a state in which the medium discharge unit of the first embodiment discharges a medium.

FIG. 6 is a side view illustrating a state in which the medium discharge unit of the first embodiment discharges a medium.

FIG. 7 is a side view illustrating a state in which the medium discharge unit of the first embodiment discharges a medium.

FIG. 8 is a side view illustrating a medium discharge unit of a second embodiment.

FIG. 9 is a plan view illustrating the medium discharge unit of the second embodiment.

FIG. 10 is a side view illustrating a state in which the medium discharge unit of the second embodiment discharges a medium.

FIG. 11 is a side view illustrating a state in which the medium discharge unit of the second embodiment discharges a medium.

FIG. 12 is a side view illustrating a state in which the medium discharge unit of the second embodiment discharges a medium.

FIG. 13 is a side view illustrating a medium discharge unit of a third embodiment.

FIG. 14 is a side view illustrating a state in which the medium discharge unit of the third embodiment discharges a medium.

FIG. 15 is a side view illustrating a state in which the medium discharge unit of the third embodiment discharges a medium.

FIG. 16 is a side view illustrating a state in which the medium discharge unit of the third embodiment discharges a medium.

FIG. 17 is a side view illustrating a state in which the medium discharge unit of the third embodiment discharges a medium.

FIG. 18 is a side view schematically illustrating a configuration of a medium discharge unit of a fourth embodiment.

FIG. 19 is a plan view illustrating a configuration of the medium discharge unit of the fourth embodiment.

FIG. 20 is a side view illustrating a state in which the medium discharge unit of the fourth embodiment discharges a medium.

FIG. 21 is a side view illustrating a state in which the medium discharge unit of the fourth embodiment discharges a medium.

FIG. 22 is a side view illustrating a state in which the medium discharge unit of the fourth embodiment discharges a medium.

FIG. 23 is a side view schematically illustrating a medium discharge unit of a fifth embodiment.

FIG. 24 is a plan view illustrating the medium discharge unit of the fifth embodiment.

FIG. 25 is a side view illustrating a state in which the medium discharge unit of the fifth embodiment discharges a medium.

FIG. 26 is a side view schematically illustrating a state in which the medium discharge unit of the fifth embodiment discharges a medium.

FIG. 27 is a side view schematically illustrating a state in which the medium discharge unit of the fifth embodiment discharges a medium.

### DESCRIPTION OF EMBODIMENTS

### 1. First Embodiment

With reference to the drawings, a configuration of an image reading apparatus 1 according to a first embodiment is described below.

The image reading apparatus 1 is an electronic apparatus that reads an image formed on a medium M such as paper being transported and generates image data.

Each figure illustrates X-, Y-, and Z-axes that intersect with one another. In the embodiment, the X-, Y-, and Z-axes are perpendicular to one another. The X-axis is parallel to the installation surface of the image reading apparatus 1, and corresponds to the width direction of the image reading apparatus 1. The Y-axis is parallel to the installation surface of the image reading apparatus 1, and corresponds to the depth direction of the image reading apparatus 1. The Z-axis is vertical to the installation surface of the image reading apparatus 1, and corresponds to the height direction of the image reading apparatus 1.

Hereinafter, a +X direction parallel to the X-axis is a left direction when facing the front surface of the image reading apparatus 1. A −X direction parallel to the X-axis is a direction opposite to the +X direction. A +Y direction parallel to the Y-axis is a direction from the back surface to the front surface of the image reading apparatus 1. A −Y direction parallel to the Y-axis is a direction opposite to the +Y direction. A +Z direction parallel to the Z-axis is an upward direction from the installation surface of the image reading apparatus 1. A −Z direction parallel to the Z-axis is a direction opposite to the +Z direction. In the embodiment, a ±Z direction is parallel to the vertical direction.

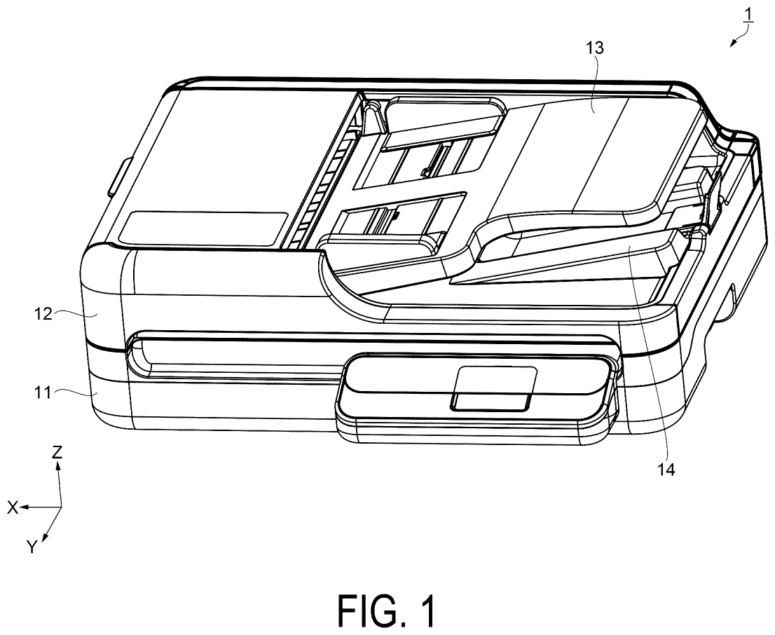

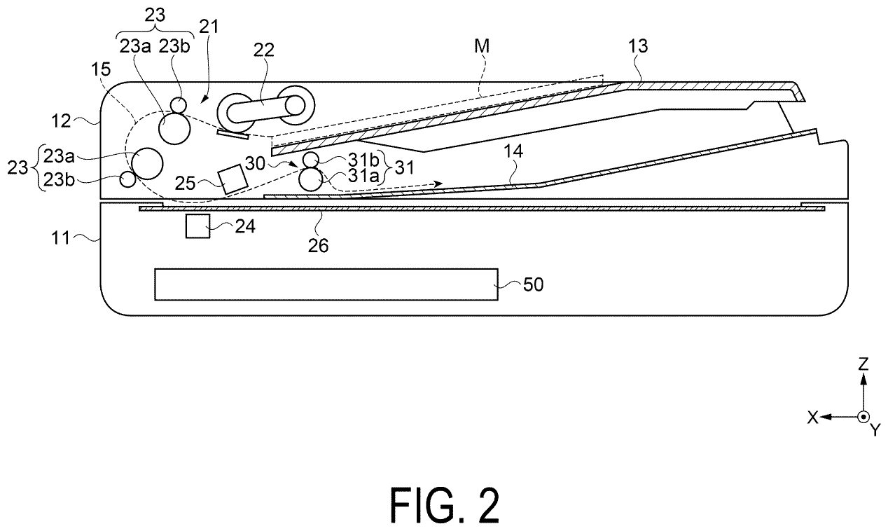

FIG. 1 is a perspective view illustrating a schematic configuration of the image reading apparatus 1, and FIG. 2 is a cross-sectional view illustrating an internal structure of the image reading apparatus 1.

As illustrated in FIG. 1, the image reading apparatus 1 includes a lower unit 11 and an upper unit 12. The upper unit 12 is arranged on the upper side of the lower unit 11. The upper unit 12 includes a sheet supply unit 13 on which the medium M before being read is placed and a sheet ejection unit 14 on which the medium M after being read is placed. It is configured so that the plurality of media M (see FIG. 2) are stacked on the sheet supply unit 13 and the sheet ejection unit 14. The upper unit 12 is openable and closeable with respect to the lower unit 11. The sheet ejection unit 14 is an example of the placement unit.

As illustrated in FIG. 2, in the upper unit 12 of the image reading apparatus 1, a transport path 15 for the medium M, which is indicated by the broken line, is formed. The transport path 15 is a path that passes from the sheet supply unit 13 through the inside of the upper unit 12, passes between the lower unit 11 and the upper unit 12, and then arrives at the sheet ejection unit 14. The transport path 15 is bent inside the upper unit 12.

The image reading apparatus 1 includes a medium transport unit 21 inside the upper unit 12. The medium transport unit 21 includes a feeding unit 22 and a plurality of transport roller pairs 23. The feeding unit 22 separates the uppermost medium M from the plurality of media M stacked on the sheet supply unit 13, and feeds the media one at a time into the transport path 15. The transport roller pair 23 includes a driving roller 23a that rotates by driving of a driving device (for example, a motor), which is omitted in illustration, and a driven roller 23b that rotates in response to rotation of the driving roller 23a. The transport roller pair 23 transports the medium M while nipping the medium M between the driving roller 23a and the driven roller 23b. The medium transport unit 21 transports the medium M along the transport path 15 toward a discharge roller pair 31, which is described later. The medium transport unit 21 is an example of the transport unit.

The image reading apparatus 1 includes a first sensor unit 24 and a second sensor unit 25 at a position adjacent to the transport path 15. For example, the first sensor unit 24 and the second sensor unit 25 include sensors of a contact image sensor (CIS) type extending along the Y-axis. However, the sensors of the first sensor unit 24 and the second sensor unit 25 may be sensors of other types such as a charge coupled device (CCD) type.

The first sensor unit 24 is accommodated in the lower unit 11. A document table 26 that can transmit light is arranged on the upper surface of the lower unit 11, and the first sensor unit 24 faces, via the document table 26, the first surface of the medium M being transported. The first sensor unit 24 reads an image formed on the first surface of the medium M being transported. Note that the first sensor unit 24 is movable in the +X direction, and can also read an image on the medium M placed on the document table 26 while opening the upper unit 12, in addition to the medium M being transported in the transport path 15.

The second sensor unit 25 is accommodated inside the upper unit 12, and is arranged downstream of the first sensor unit 24 in the transport path 15. The second sensor unit 25 faces a second surface opposite to the first surface of the medium M being transported, and reads an image formed on the second surface.

The image reading apparatus 1 includes a medium discharge unit 30 downstream of the medium transport unit 21, the first sensor unit 24, and the second sensor unit 25 in the transport path 15. The medium discharge unit 30 discharges the medium M toward the sheet ejection unit 14 after the images thereon are read by the first sensor unit 24 and the second sensor unit 25. The medium discharge unit 30 is an example of the medium discharge device.

The medium discharge unit 30 includes the discharge roller pair 31 configured by a first roller 31a and a second roller 31b. The first roller 31a rotates by driving of a driving device (for example, a motor), which is omitted in illustration. The second roller 31b is positioned above, in other words, on the +Z side of the first roller 31a, and rotates in response to rotation of the first roller 31a. The discharge roller pair 31 discharges the medium M to the sheet ejection unit 14 while nipping the medium M between the first roller 31a and the second roller 31b. The discharge roller pair 31 is an example of the roller pair.

The image reading apparatus 1 includes a control unit 50 inside the lower unit 11. The control unit 50 includes a processor such as a central processing unit (CPU), and controls an operation of the image reading apparatus 1. In other words, the control unit 50 controls operations of the medium transport unit 21, the first sensor unit 24, the second sensor unit 25, and the medium discharge unit 30.

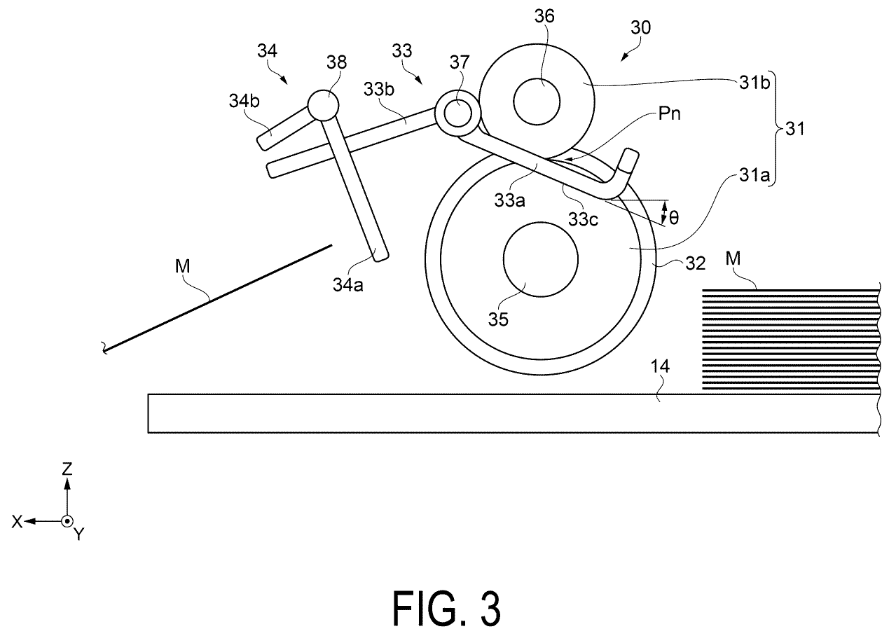

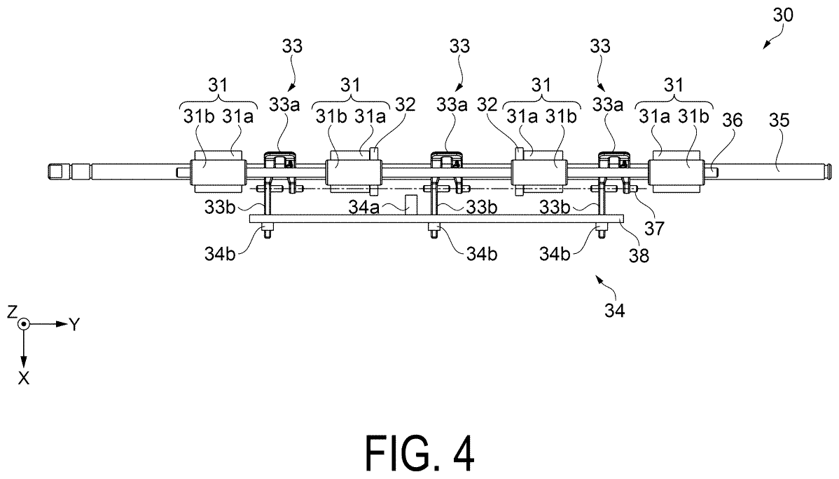

FIG. 3 is a side view illustrating a configuration of the medium discharge unit 30, and FIG. 4 is a plan view illustrating a configuration of the medium discharge unit 30. Hereinafter, a direction in which the medium discharge unit 30 discharges the medium M is also referred to as a discharge direction. In the embodiment, the discharge direction is substantially the −X direction. Further, the ±Y direction intersecting with the discharge direction is also referred to as a width direction of the medium M.

As illustrated in FIG. 3, in addition to the discharge roller pair 31 described above, the medium discharge unit 30 includes a scraping member 32, a first pressing member 33, and a lifting member 34. The scraping member 32 scrapes the medium M out of the discharge roller pair 31. The first pressing member 33 presses the discharged medium M against the first roller 31a. The lifting member 34 changes the posture of the first pressing member 33 as the medium M moves. Those configurations are described later in detail.

As illustrated in FIG. 4, the medium discharge unit 30 includes the plurality of discharge roller pairs 31 along the ±Y direction. In the embodiment, the medium discharge unit 30 includes the four discharge roller pairs 31 along the ±Y direction. In other words, the medium discharge unit 30 includes the four first rollers 31a and the four second rollers 31b along the ±Y direction.

The four first rollers 31a are fixed to a rotation shaft 35 extending along the ±Y direction. The four first rollers 31a rotate about the rotation shaft 35 by driving of a driving device, which is omitted in illustration. The four second rollers 31b are fixed to a rotation shaft 36 extending along the ±Y direction. The four second rollers 31b rotate about the rotation shaft 36 in response to rotation of the first roller 31a. For example, the rotation shafts 35 and 36 are supported rotatably by the casing body of the upper unit 12 or the like.

The medium discharge unit 30 includes the plurality of scraping members 32. In the embodiment, the medium discharge unit 30 includes the two scraping members 32. Each of the two scraping members 32 is arranged to be adjacent to the inner surface sides of the two first rollers 31a, which are positioned inside, among the four first rollers 31a. Specifically, one of the scraping members 32 is arranged to be adjacent to the −Y side of the second first roller 31a to the +Y side. The other scraping member 32 is arranged to be adjacent to the +Y side of the third first roller 31a to the +Y side.

For example, the scraping member 32 is a disk-like member formed of sponge or the like. In other words, the scraping member 32 has a surface on which fine irregularities are formed, and can be elastically deformed. The scraping member 32 rotates together with the first roller 31a about the rotation shaft 35 by driving of a driving device, which is omitted in illustration. In other words, the scraping member 32 rotates coaxially with the first roller 31a, and nips the medium M with the second roller 31b. The scraping member 32 utilizes the irregularities on the surface to scrape the medium M in the discharge direction.

The diameter of the scraping member 32 is larger than the diameter of the first roller 31a. However, the scraping member 32, which is formed of sponge or the like, is deformed and compressed when contacting with the second roller 31b and the medium M. Note that the scraping member 32 is not limited to sponge, and is only required to be configured by an elastic member including a surface on which fine irregularities are formed. Further, the medium discharge unit 30 may be configured without the scraping member 32.

The medium discharge unit 30 includes the plurality of first pressing members 33 arrayed along the ±Y direction being the axial direction of the first roller 31a. In the embodiment, the medium discharge unit 30 includes the three first pressing members 33 arrayed along the ±Y direction. The first pressing members 33 are arranged, with one placed between each of the four discharge roller pairs 31. Each of the first pressing members 33 includes a rotation shaft 37 positioned on a commonly-shared imaginary linear line, and can rotate about the rotation shaft 37. The rotation shaft 37 of the first pressing member 33 is arranged on the +X side, in other words, upstream of the rotation shaft 35 of the first roller 31a and the rotation shaft 36 of the second roller 31b in the discharge direction. For example, the rotation shaft 37 is supported rotatably by the casing of the upper unit 12 or other structural bodies. The rotation shaft 37 is an example of the first rotation shaft.

The first pressing member 33 includes a medium pressing portion 33a extending from the rotation shaft 37 to the −X side and a lever portion 33b extending from the rotation shaft 37 to the +X side. The first pressing member 33 rotates. With this, the medium pressing portion 33a is movable below a nipping position Pn at which the discharge roller pair 31 nips the medium M. Further, the first pressing member 33 presses down the medium M being discharged, by the medium pressing portion 33a moving downward. When the first pressing member 33 rotates, the lever portion 33b contacts with the lifting member 34. The medium pressing portion 33a is an example of the first member, and the lever portion 33b is an example of the second member.

The weight of the medium pressing portion 33a is more than the weight of the lever portion 33b. Thus, while the discharge roller pair 31 does not nip the medium M, the medium pressing portion 33a is displaced downward due to the own weight. Specifically, as illustrated in FIG. 3, the medium pressing portion 33a is positioned below the nipping position Pn of the discharge roller pair 31. While the discharge roller pair 31 does not nip the medium M, the position of the medium pressing portion 33a corresponds to the first position. Note that, in the present specification, the position of the medium pressing portion 33a is a position of a part of the medium pressing portion 33a, which actually contacts with the medium M.

The lifting member 34 presses down the lever portion 33b of the first pressing member 33 to change the posture of the first pressing member 33. The lifting member 34 includes a rotation shaft 38 extending along the ±Y direction, and can rotate about the rotation shaft 38. The rotation shaft 38 is arranged on the +X side, in other words, upstream of the rotation shaft 37 of the first pressing member 33 in the discharge direction. For example, the rotation shaft 38 is supported rotatably by the casing of the upper unit 12 or other structural bodies. The rotation shaft 38 is an example of the second rotation shaft.

The lifting member 34 includes one medium contacting portion 34a extending from the rotation shaft 38 to the −X side and three lever pressing portion 34b extending from the rotation shaft 38 to the +X side. Specifically, the medium contacting portion 34a extends in a direction containing a −X component and a −Z component so as to intersect with the transport path 15, and contacts with the medium M being transported. Further, each of the three lever pressing portions 34b faces the lever portion 33b of the first pressing member 33. Thus, when the lifting member 34 rotates in a counterclockwise direction in FIG. 3, the lever pressing portion 34b contacts with the lever portion 33b, and presses down the lever portion 33b. The medium contacting portion 34a is an example of the third member, and the lever pressing portion 34b is an example of the fourth member.

When the lever portion 33b of the first pressing member 33 is pressed down, the medium pressing portion 33a is elevated. The position of the medium pressing portion 33a after elevation corresponds to the second position. The second position is a position above the first position. In this manner, the lifting member 34 lifts up the medium pressing portion 33a of the first pressing member 33 from the first position below the nipping position Pn of the discharge roller pair 31 to the second position above the first position. In the embodiment, the second position is a position substantially at the same height as the nipping position Pn of the discharge roller pair 31.

Next, an operation of the medium discharge unit 30 is described.

When reading of an image formed on the medium M is executed, the medium transport unit 21 takes one medium M from the sheet supply unit 13 into the transport path 15, based on control of the control unit 50. The medium transport unit 21 transports the medium M, which is taken in, along the transport path 15 toward the medium discharge unit 30. Further, the first sensor unit 24 and the second sensor unit 25 read the image formed on the medium M being transported, based on control of the control unit 50. Further, the first roller 31a rotates based on control of the control unit 50. With this, the medium discharge unit 30 discharges, to the sheet ejection unit 14, the medium M after reading the image thereon.

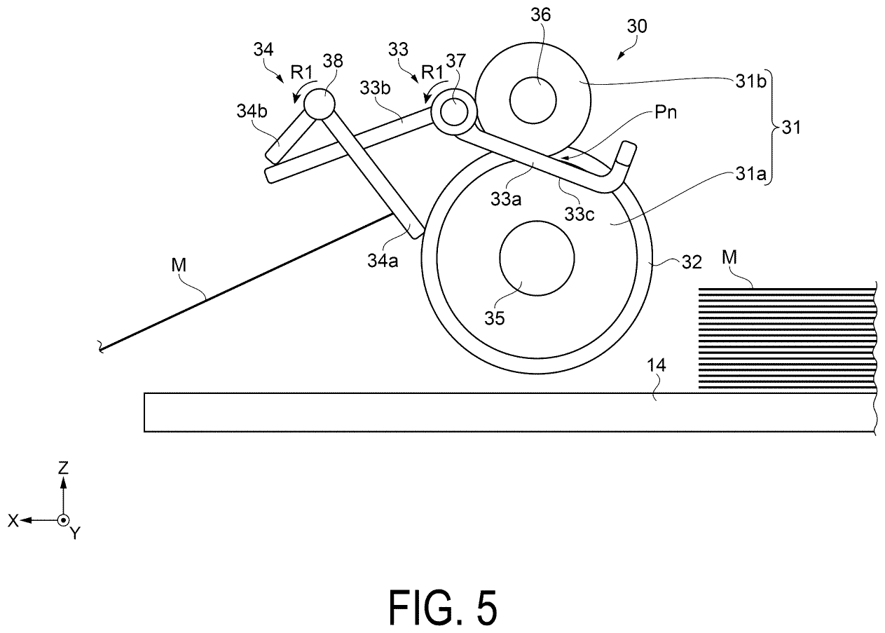

FIG. 5 to FIG. 7 are side views illustrating a state in which the medium discharge unit 30 of the embodiment discharges the medium M.

As illustrated in FIG. 5, the medium M transported by the medium transport unit 21 contacts with the medium contacting portion 34a of the lifting member 34 upstream of the nipping position Pn of the discharge roller pair 31 in the transport direction, and the medium contacting portion 34a moves downstream. With this, the lifting member 34 rotates about the rotation shaft 38 in a first direction R1, that is, a counterclockwise direction in FIG. 5. As a result, the lever pressing portion 34b of the lifting member 34 contacts with the lever portion 33b of the first pressing member 33.

Further, when the medium M moves downstream, the lifting member 34 further rotates in the first direction R1. With this, the lever pressing portion 34b presses down the lever portion 33b. With this, the first pressing member 33 rotates about the rotation shaft 37 in the first direction R1. As the first pressing member 33 rotates in the first direction R1, the medium pressing portion 33a is lifted upward.

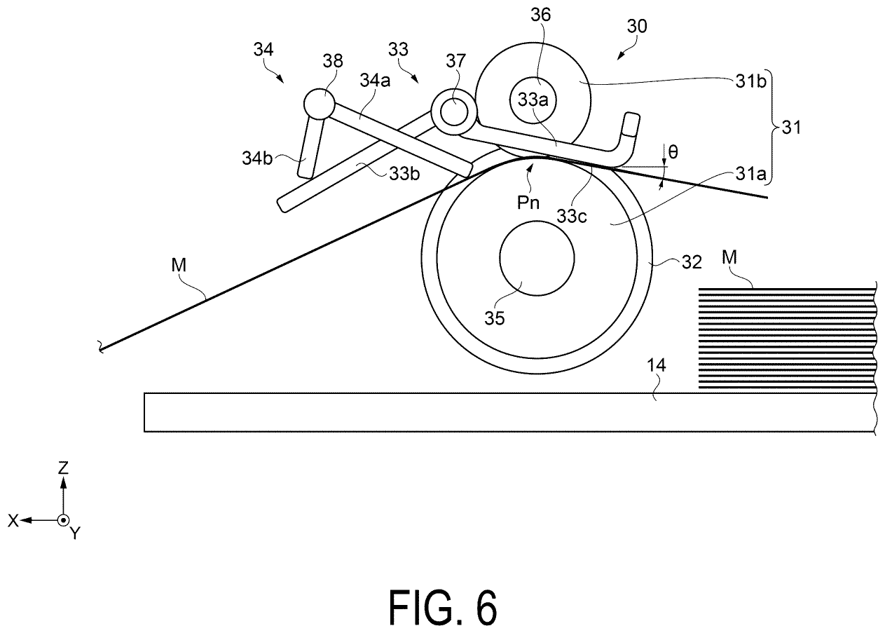

Elevation of the medium pressing portion 33a due to rotation of the first pressing member 33 continues until the distal end of the medium contacting portion 34a abuts against the upper surface of the medium M. Further, as illustrated in FIG. 6, when the leading edge of the medium M, in other words, the downstream edge thereof in the discharge direction passes through the nipping position Pn of the discharge roller pair 31, the distal end of the medium contacting portion 34a abuts against the upper surface of the medium M. Hereinafter, the postures of the lifting member 34 and the first pressing member 33 are substantially constant. In this state, the medium pressing portion 33a extends along the discharge direction, and an abutting surface 33c facing the medium M contacts with the upper surface of the medium M. As described above, the position of the medium pressing portion 33a lifted by the lifting member 34 corresponds to the second position. In other words, when the downstream leading edge of the medium M in the discharge direction passes through the nipping position Pn, the first pressing member 33 rotates in the first direction R1. With this, the medium pressing portion 33a moves from the first position to the second position. In other words, the medium pressing portion 33a is lifted by the lifting member 34, and thus moves from the first position to the second position.

Herein, it is assumed that the medium pressing portion 33a is not elevated. When the edges of the medium M in the width direction, in other words, the edges of the medium M in the ±Y direction are present in the vicinity of the position of the medium pressing portion 33a, the medium pressing portion 33a may significantly press down the edges of the medium M in the width direction. In particular, when rigidity of the medium M is low, the medium M easily hangs down. In this case, the leading edge of the discharged medium M in the width direction collide with the trailing edge of the medium M on the sheet ejection unit 14. With this, the medium M on the sheet ejection unit 14 may be disorganized. In view of this, in the embodiment, when the leading edge of the medium M passes through the nipping position Pn, the medium pressing portion 33a is elevated. With this, the edges of the medium M in the width direction can be prevented from being pressed down.

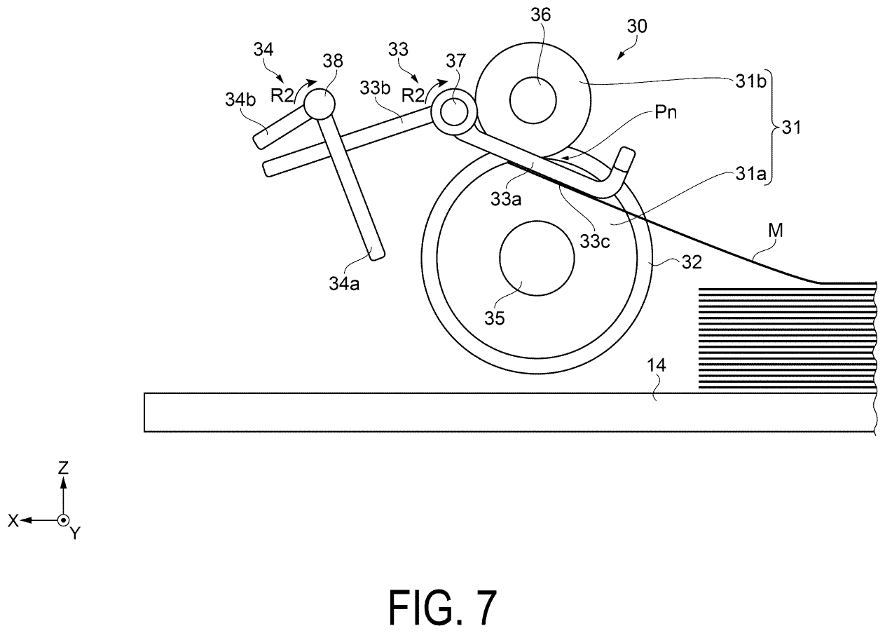

After that, the medium M is further discharged, and the trailing edge of the medium M, in other words, the upstream edge thereof in the discharge direction is separated from the medium contacting portion 34a. In this state, as illustrated in FIG. 7, the medium contacting portion 34a is lowered due to the own weight. In other words, the lifting member 34 rotates about the rotation shaft 38 in a second direction R2 opposite to the first direction R1. With this, the lever pressing portion 34b of the lifting member 34 is separated from the lever portion 33b of the first pressing member 33. Further, when the lever pressing portion 34b is separated from the lever portion 33b, the medium pressing portion 33a is lowered due to the own weight. With this, the first pressing member 33 rotates about the rotation shaft 37 in the second direction R2. As a result, the first pressing member 33 presses down the medium M by the own weight of the medium pressing portion 33a, and presses the medium M against the first roller 31a. In this state, the medium M is warped downward between the first rollers 31a. Thus, the position of the medium pressing portion 33a is below the nipping position Pn of the discharge roller pair 31. Further, the medium pressing portion 33a continues pressing the medium M until the medium M is separated. Note that, in FIG. 7, the part of the medium M that is nipped, the part thereof that contacts with the circumferential surface of the first roller 31a, and the like are omitted in illustration. After that, when the medium M is separated from the medium pressing portion 33a, the position of the medium pressing portion 33a returns to the first position before the medium M is charged. In this manner, when the upstream trailing edge of the medium M in the discharge direction passes through the nipping position Pn, the first pressing member 33 rotates about the rotation shaft 37 in the second direction R2. With this, the medium pressing portion 33a moves from the second position to the first position.

Note that, as illustrated in FIG. 3 and FIG. 6, when the medium pressing portion 33a is positioned at the first position (see FIG. 3), a region in which the medium pressing portion 33a and the first roller 31a overlap with each other as viewed in the ±Y direction being the axial direction of the first roller 31a is larger than that in a case in which the medium pressing portion 33a is positioned at the second position (see FIG. 6). Further, when the medium pressing portion 33a is positioned at the first position (see FIG. 3), an angle θ of the medium pressing portion 33a with respect to the horizontal plane is larger than that in a case in which the medium pressing portion 33a is positioned at the second position (see FIG. 6). Herein, the angle θ of the medium pressing portion 33a with respect to the horizontal plane indicates an angle formed between the abutting surface 33c of the medium pressing portion 33a, which contacts with the medium M, and the horizontal plane.

As described above, according to the medium discharge unit 30 and the image reading apparatus 1 of the embodiment, the following effects can be obtained.

according to the embodiment, when the leading edge of the medium M passes through the nipping position Pn, the medium pressing portion 33a of the first pressing member 33 is lifted up by the lifting member 34. With this, the edges of the medium M in the width direction can be prevented from being pressed down. In other words, the entry angle of the downstream edge of the medium M, in other words, the angle of the medium M with respect to the horizontal plane is reduced. As a result, collision between the leading edge of the discharged medium M and the trailing edge of the medium M on the sheet ejection unit 14 is avoided, and hence disorganization of the medium M on the sheet ejection unit 14 is suppressed. In contrast, when the trailing edge of the medium M passes through the nipping position Pn, the medium pressing portion 33a moves downward. With this, the medium M is pressed against the first roller 31a by the first pressing member 33. With this, a force of transporting the medium M downstream is increased. As a result, the medium M moves as the first roller 31a rotates. Thus, the trailing edge of the medium M can be prevented from remaining at the discharge roller pair 31.

Further, according to the embodiment, the medium M transported by the medium transport unit 21 contacts with the medium contacting portion 34a, and the lifting member 34 rotates in the first direction R1. With this, the medium pressing portion 33a is elevated from the first position to the second position. In other words, the medium pressing portion 33a can be elevated with a simple configuration.

Further, according to the embodiment, the discharged medium M is separated from the lifting member 34. With this, the medium pressing portion 33a is lowered from the second position to the first position. In other words, the medium pressing portion 33a can be lowered with a simple configuration.

Further, according to the embodiment, when the medium pressing portion 33a is positioned at the first position, a region in which the medium pressing portion 33a and the first roller 31a overlap with each other is larger than that in a case in which the medium pressing portion 33a is positioned at the second position. In other words, when the medium pressing portion 33a is positioned at the first position, the medium M is pressed against the first roller 31a. Thus, the trailing edge of the medium M can be prevented from remaining at the discharge roller pair 31. In contrast, when the medium pressing portion 33a is positioned at the second position, a region in which the medium pressing portion 33a and the first roller 31a overlap with each other is smaller than that in a case in which the medium pressing portion 33a is positioned at the first position. Thus, at the leading edge of the medium M, the edges thereof in the width direction can be prevented from being pressed down.

Further, according to the embodiment, when the medium pressing portion 33a is positioned at the first position, the angle of the medium pressing portion 33a with respect to the horizontal plane is larger than that in a case in which the medium pressing portion 33a is positioned at the second position. In other words, when the medium pressing portion 33a is positioned at the first position, the medium M is pressed against the first roller 31a. Thus, the trailing edge of the medium M can be prevented from remaining at the discharge roller pair 31. In contrast, when the medium pressing portion 33a is positioned at the second position, the angle of the medium pressing portion 33a with respect to the horizontal plane is smaller than that in a case in which the medium pressing portion 33a is positioned at the first position. Thus, at the leading edge of the medium M, the edges thereof in the width direction can be prevented from being pressed down.

Further, according to the embodiment, the plurality of first pressing members 33 are arrayed along the axial direction of the first roller 31a. Thus, the medium M having various sizes can effectively be pressed by the first pressing member 33.

Further, according to the embodiment, t the discharge roller pair 31, the medium M is scraped by the scraping member 32. Thus, the trailing edge of the medium M can further be prevented from remaining at the discharge roller pair 31.

### 2. Second Embodiment

Next, the image reading apparatus 1 according to a second embodiment is described.

The image reading apparatus 1 of the embodiment includes a medium discharge unit 30A different from the medium discharge unit 30 of the first embodiment. The configurations other than the medium discharge unit 30A are similar to those in the first embodiment, and hence description thereof is omitted.

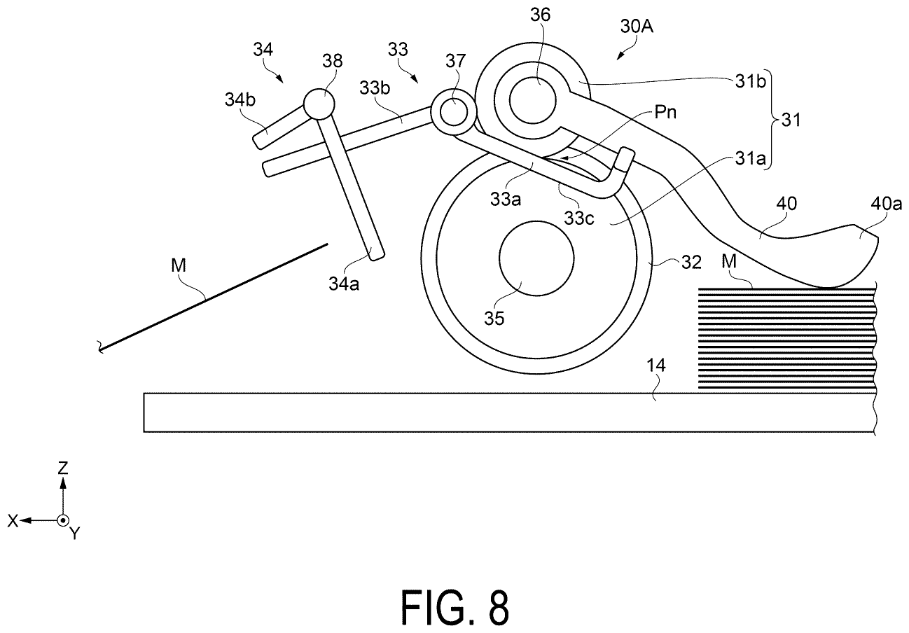

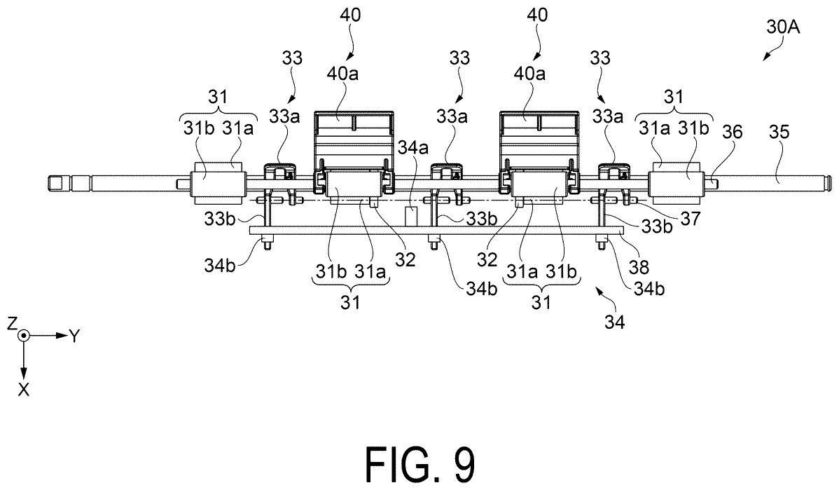

FIG. 8 is a side view illustrating the medium discharge unit 30A of the embodiment, and FIG. 9 is a plan view illustrating the medium discharge unit 30A.

As illustrated in FIG. 8 and FIG. 9, the medium discharge unit 30A of the embodiment includes two second pressing members 40 in addition to the configuration of the medium discharge unit 30 of the first embodiment. The second pressing member 40 is a plate-like member having a substantially rectangular shape in plan view, and is formed to have a wave-like form as viewed from a side. The end portion of the second pressing member 40 on the +X side is rotatably attached to the rotation shaft 36 of the second roller 31b. Further, a pressing end portion 40a being an end portion of the second pressing member 40 on the −X side is a free end, and is positioned on the sheet ejection unit 14. When the medium M is placed on the sheet ejection unit 14, the second pressing member 40 presses the medium M by the own weight toward the sheet ejection unit 14. In this manner, on the sheet ejection unit 14 present in the discharge direction with respect to the medium pressing portion 33a of the first pressing member 33, the second pressing member 40 presses the medium M, which is discharged from the discharge roller pair 31, toward the sheet ejection unit 14.

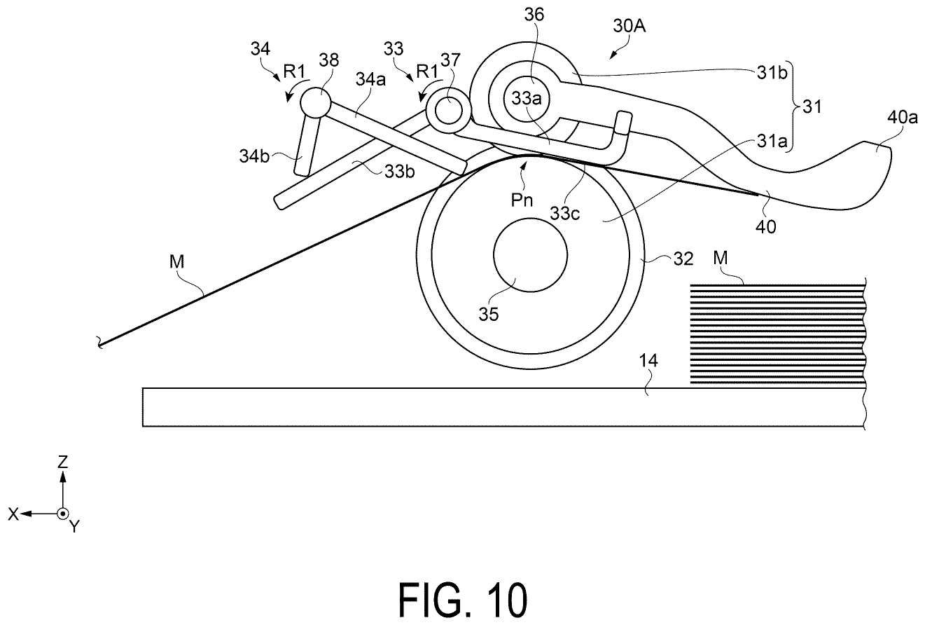

FIG. 10 to FIG. 12 are side views illustrating a state in which the medium discharge unit 30A of the embodiment discharges the medium M.

As illustrated in FIG. 10, similarly to the first embodiment, when the medium M transported by the medium transport unit 21 arrives at the medium discharge unit 30A, the lifting member 34 lifts up the medium pressing portion 33a of the first pressing member 33. Further, the leading edge of the medium M that passes through the nipping position Pn of the discharge roller pair 31 abuts against the second pressing member 40, and the second pressing member 40 rotates so as to elevate the pressing end portion 40a. In contrast, while being pressed down by the own weight of the second pressing member 40, the medium M is transported toward the sheet ejection unit 14.

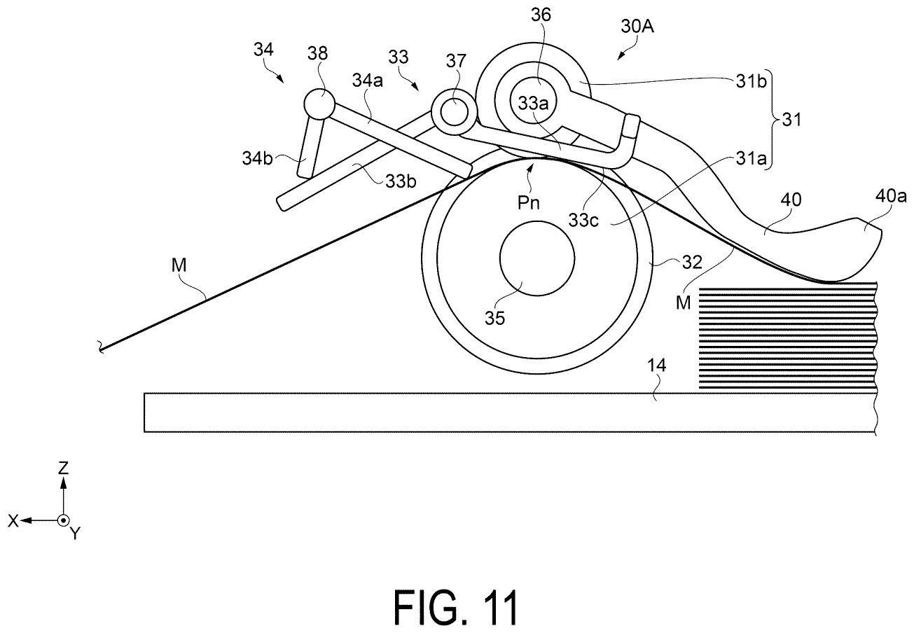

As illustrated in FIG. 11, when the medium M is further discharged, the medium M passing through the nipping position Pn of the discharge roller pair 31 is warped downward. With this, the pressing end portion 40a of the second pressing member 40 is lowered. Further, the medium M passing through the pressing end portion 40a of the second pressing member 40 moves along the upper surface of the sheet ejection unit 14 or the upper surface of the medium M placed on the sheet ejection unit 14.

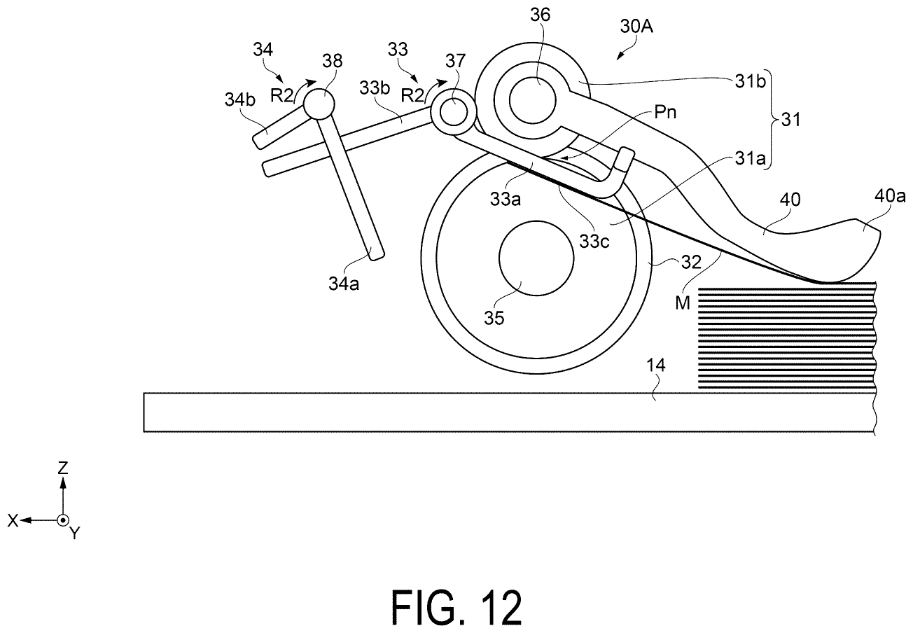

As illustrated in FIG. 12, similarly to the first embodiment, when the medium M is further discharged, and the trailing edge of the medium M is separated from the medium contacting portion 34a, the medium contacting portion 34a is lowered due to the own weight. With this, the medium pressing portion 33a also moves downward. As a result, the first pressing member 33 presses down the medium M by the own weight of the medium pressing portion 33a, and presses the medium M against the first roller 31a. After that, while being pressed by the second pressing member 40, the trailing edge of the medium M arrives at the sheet ejection unit 14. Note that, in FIG. 12, the part of the medium M that is nipped, the part thereof that contacts with the circumferential surface of the first roller 31a, and the like are also omitted in illustration.

As described above, according to the medium discharge unit 30A and the image reading apparatus 1 of the embodiment, the following effects can be obtained.

According to the embodiment, the medium M discharged from the discharge roller pair 31 is pressed toward the sheet ejection unit 14 by the second pressing member 40. Thus, the medium M can be prevented from being excessively transported downstream in the sheet ejection unit 14, and alignment of the medium M can be improved.

### 3. Third Embodiment

Next, the image reading apparatus 1 according to a third embodiment is described.

The image reading apparatus 1 of the embodiment includes a medium discharge unit 30B different from the medium discharge units 30 and 30A of the first and second embodiments. The configurations other than the medium discharge unit 30B are similar to those in the first and second embodiments, and hence description thereof is omitted.

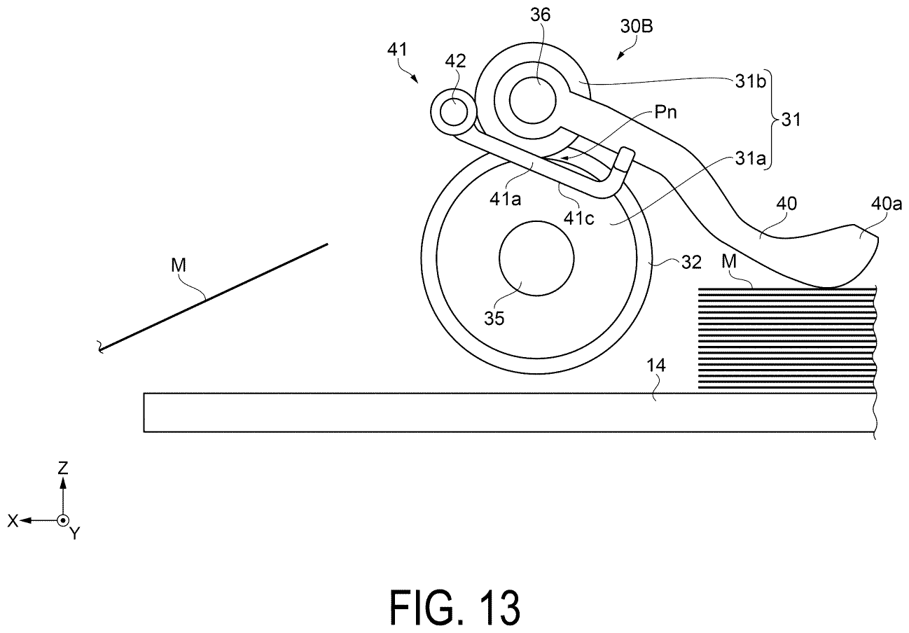

FIG. 13 is a side view illustrating the medium discharge unit 30B of the embodiment.

As illustrated in FIG. 13, the medium discharge unit 30B of the embodiment is different from the medium discharge units 30 and 30A of the first and second embodiments in that the lifting member 34 is not provided. Further, the medium discharge unit 30B includes a first pressing member 41 having a shape different from the first pressing member 33 of the first and second embodiments.

Specifically, similarly to the first pressing member 33, the first pressing member 41 includes a medium pressing portion 41a extending from a rotation shaft 42 to the −X side. In contrast, the first pressing member 41 is different from the first pressing member 33 in that the lever portion 33b extending to the +X side is not provided. The first pressing member 41 rotates. With this, the medium pressing portion 41a is movable below the nipping position Pn at which the discharge roller pair 31 nips the medium M. Further, the first pressing member 41 can press down the medium M being discharged, by the medium pressing portion 41a moving downward. The medium pressing portion 41a is an example of the first member.

While the discharge roller pair 31 does not nip the medium M, the medium pressing portion 41a of the first pressing member 41 is displaced downward due to the own weight. Specifically, as illustrated in FIG. 13, the medium pressing portion 41a positioned below the nipping position Pn of the discharge roller pair 31. In this state, the medium pressing portion 41a extends in a direction containing a −X component and a −Z component, and intersects with the transport path 15.

Further, similarly to the second embodiment, the medium discharge unit 30B includes the second pressing member 40. On the sheet ejection unit 14 that is present in the discharge direction with respect to the medium pressing portion 41a of the first pressing member 41, the second pressing member 40 presses the medium M, which is discharged from the discharge roller pair 31, toward the sheet ejection unit 14.

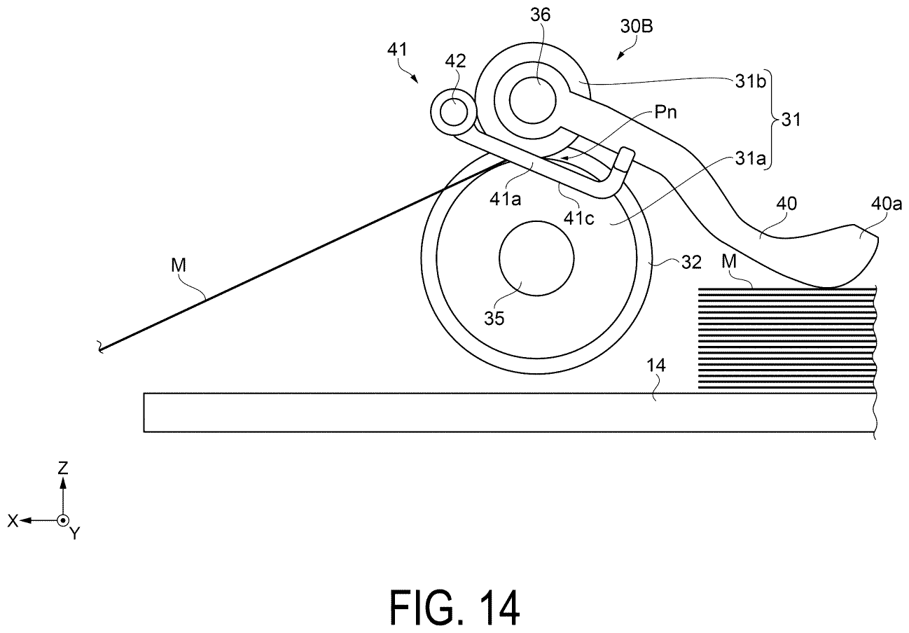

FIG. 14 to FIG. 17 are side views illustrating a state in which the medium discharge unit 30B of the embodiment discharges the medium M.

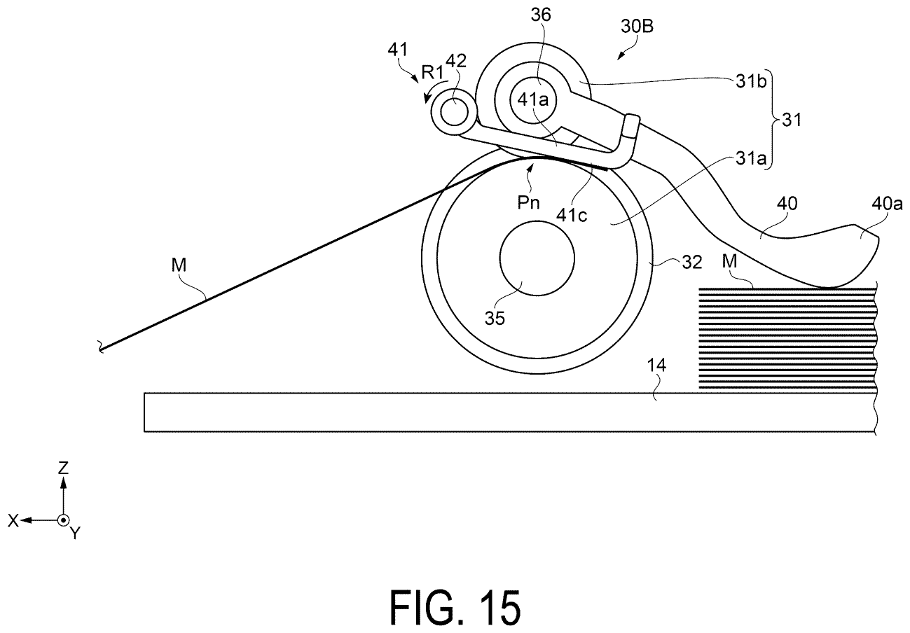

As illustrated in FIG. 14, when the medium M transported by the medium transport unit 21 arrives at the medium discharge unit 30B, the leading edge of the medium M contacts with the medium pressing portion 41a. Further, as illustrated in FIG. 15, the medium M moves further downstream, and is nipped by the discharge roller pair 31. In this process, the medium pressing portion 41a is elevated, and the first pressing member 41 rotates in the first direction R1.

When the medium M is nipped by the discharge roller pair 31, the posture of the first pressing member 41 is substantially constant. In this state, the medium pressing portion 41a extends along the discharge direction, and an abutting surface 41c facing the medium M contacts with the upper surface of the medium M. In this state, the first pressing member 41 presses down the medium M by the own weight, and thus presses the medium M against the first roller 31a.

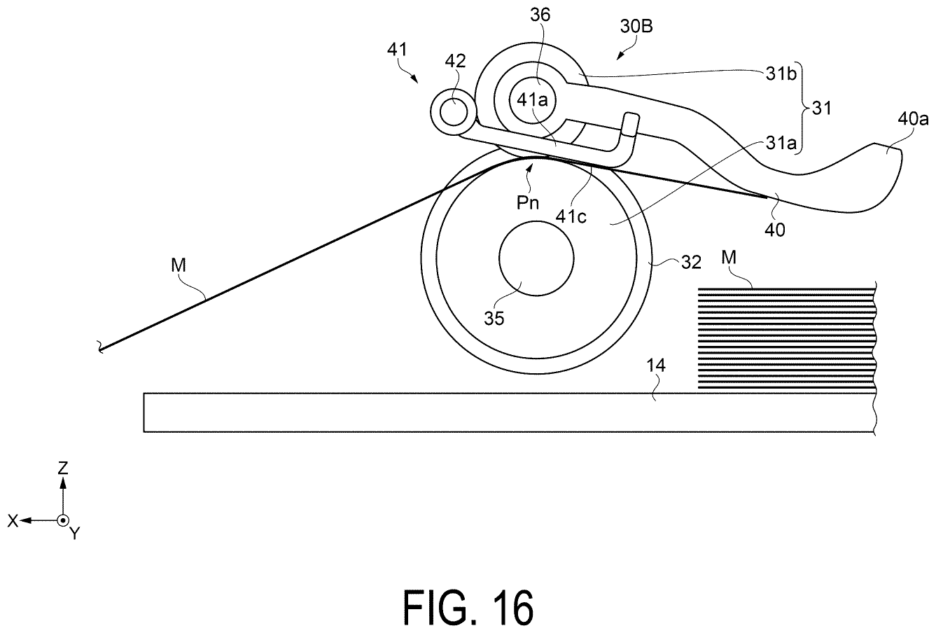

As illustrated in FIG. 16, the leading edge of the medium M that passes through the nipping position Pn of the discharge roller pair 31 abuts against the second pressing member 40, and the second pressing member 40 rotates so as to elevate the pressing end portion 40a. In contrast, while being pressed down by the own weight of the second pressing member 40, the medium M is transported toward the sheet ejection unit 14.

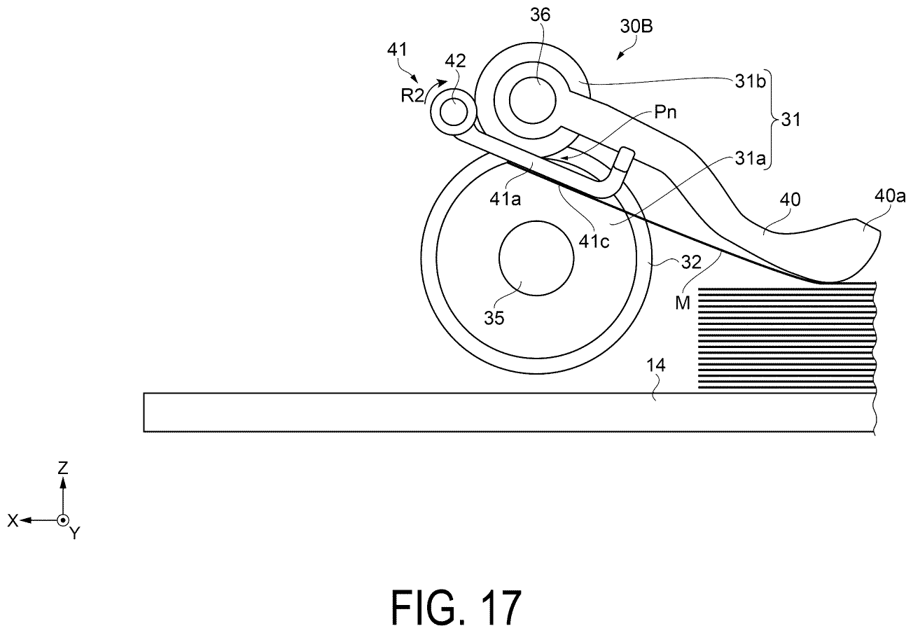

Further, as illustrated in FIG. 17, when the medium M is further discharged, and the trailing edge of the medium M arrives at the vicinity of the nipping position Pn of the discharge roller pair 31, the medium M is warped downward due to the weight of the medium pressing portion 41a. With this, the medium pressing portion 41a moves downward. In other words, the first pressing member 41 rotates in the second direction R2. As a result, the first pressing member 41 presses down the medium M by the own weight of the medium pressing portion 41a, and thus presses the medium M against the first roller 31a. Further, the medium pressing portion 41 continues pressing the medium M until the medium M is separated. After that, the medium M is separated from the medium pressing portion 41a, the position of the medium pressing portion 41a returns to the position before the medium M is discharged. Further, while being pressed by the second pressing member 40, the trailing edge of the medium M arrives at the sheet ejection unit 14. Note that, in FIG. 17, the part of the medium M that is nipped, the part thereof that contacts with the circumferential surface of the first roller 31a, and the like are also omitted in illustration.

As described above, according to the medium discharge unit 30B and the image reading apparatus 1 of the embodiment, the following effects can be obtained.

According to the embodiment, when the discharge roller pair 31 nips the medium M, the medium pressing portion 41a extends along the discharge direction. Thus, the first pressing member 41 can press a wide range of the medium M. Thus, the trailing edge of the medium M can be prevented from remaining at the discharge roller pair 31. Further, the discharged medium M is pressed toward the sheet ejection unit 14 by the second pressing member 40. Thus, the medium M can be prevented from being excessively transported downstream in the sheet ejection unit 14. With this, alignment of the medium M can be improved.

### 4. Fourth Embodiment

Next, the image reading apparatus 1 according to a fourth embodiment is described.

The image reading apparatus 1 of the embodiment includes a medium discharge unit 60 different from the medium discharge units 30, 30A, and 30B of the first to third embodiments. The configurations other than the medium discharge unit 60 are similar to those in the first to third embodiments, and hence description thereof is omitted.

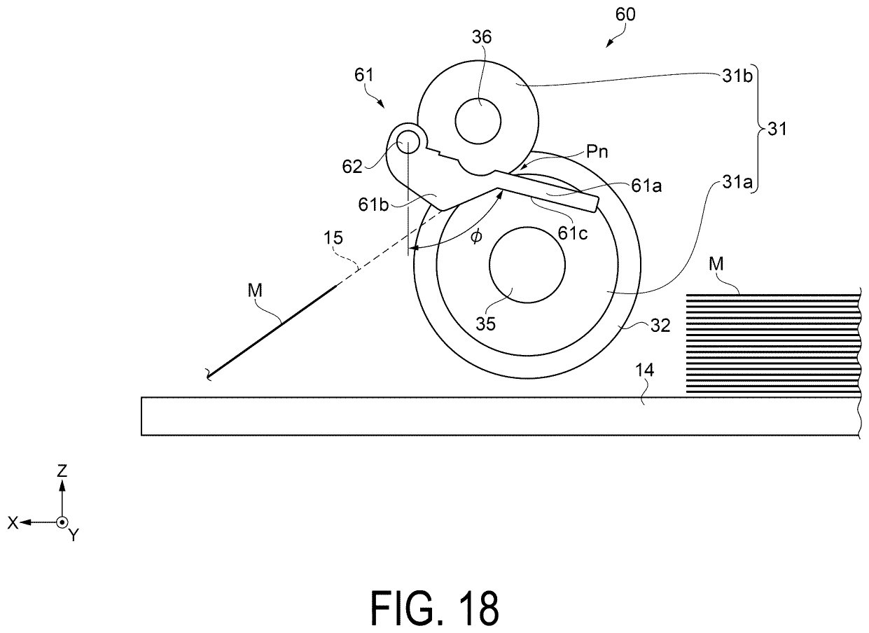

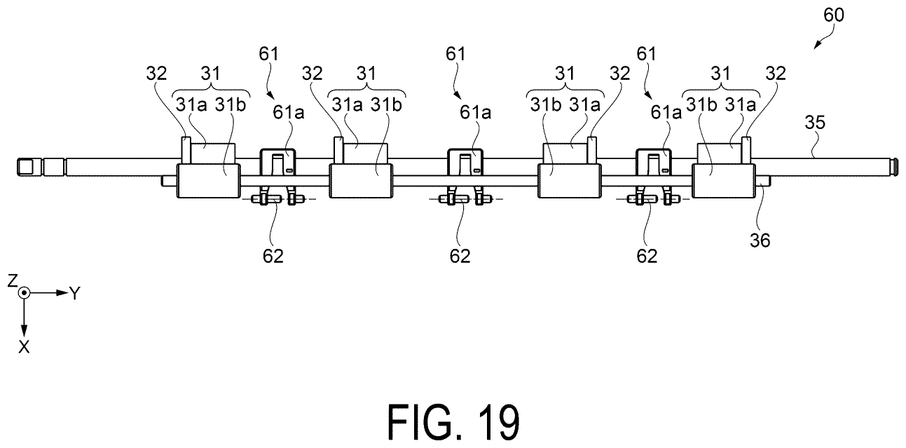

FIG. 18 is a side view schematically illustrating a configuration of the medium discharge unit 60, and FIG. 19 is a plan view illustrating a configuration of the medium discharge unit 60.

As illustrated in FIG. 18, the medium discharge unit 60 nips the medium M, which is transported in an oblique direction containing a −X component and a +Z component along the transport path 15, between the discharge roller pair 31, and discharges the medium M to the sheet ejection unit 14.

The medium discharge unit 60 includes the scraping member 32 and a discharge assisting member 61 in addition to the discharge roller pair 31. The scraping member 32 scrapes the medium M out of the discharge roller pair 31. The discharge assisting member 61 assists in an operation of discharging the medium M discharged from the discharge roller pair 31. Specifically, the discharge assisting member 61 presses the discharged medium M against the first roller 31a. The configurations of the scraping member 32 and the discharge assisting member 61 are described later in detail.

As illustrated in FIG. 19, the medium discharge unit 60 includes the plurality of discharge roller pairs 31, and each of the plurality of discharge roller pairs 31 includes the first roller 31a and the second roller 31b. The plurality of discharge roller pairs 31 are arrayed along the ±Y direction being the axial direction of the first roller 31a. In the embodiment, the medium discharge unit 60 includes the four discharge roller pairs 31. In other words, the medium discharge unit 60 includes the four first rollers 31a and the four second rollers 31b along the ±Y direction.

The four first rollers 31a are fixed to the rotation shaft 35 extending along the ±Y direction. The four first rollers 31a rotate about the rotation shaft 35 by driving of a driving device, which is omitted in illustration. The four second rollers 31b are fixed to the rotation shaft 36 extending along the ±Y direction. The four second rollers 31b rotate about the rotation shaft 36 in response to rotation of the first roller 31a. The rotation shaft 36 of the second roller 31b is arranged on the +X side, in other words, upstream of the rotation shaft 35 of the first roller 31a in the discharge direction. For example, the rotation shafts 35 and 36 are supported rotatably by the casing body of the upper unit 12 or the like.

The medium discharge unit 60 includes the plurality of scraping members 32. The plurality of scraping members 32 are arrayed along the ±Y direction. In the embodiment, the medium discharge unit 60 includes the four scraping members 32 corresponding to the discharge roller pairs 31. The scraping member 32 is arranged to be adjacent to the first roller 31a of the corresponding discharge roller pair 31. Specifically, among the four scraping members 32, the two scraping members 32 that are positioned on the Y side with respect to the center are arranged so as to be adjacent to the −Y sides of the first rollers 31a. Further, among the four scraping members 32, the two scraping members 32 that are positioned on the +Y side with respect to the center are arranged so as to be adjacent to the +Y sides of the first rollers 31a.

The medium discharge unit 60 includes the plurality of discharge assisting members 61. The plurality of discharge assisting members 61 are arrayed along the ±Y direction being the axial direction of the first roller 31a. In the embodiment, the medium discharge unit 60 includes the three discharge assisting members 61. The discharge assisting members 61 are arranged, with one placed between each of the four discharge roller pairs 31. Each of the discharge assisting members 61 includes a rotation shaft 62 positioned on a commonly-shared imaginary linear line, and can rotate about the rotation shaft 62. The rotation shaft 62 of the discharge assisting member 61 is arranged on the +X side, in other words, upstream of the rotation shaft 35 of the first roller 31a and the rotation shaft 36 of the second roller 31b in the discharge direction. For example, the rotation shaft 62 is supported rotatably by the casing of the upper unit 12 or other structural bodies. The rotation shaft 62 is an example of the third rotation shaft.

As illustrated in FIG. 18, the discharge assisting member 61 includes a medium pressing portion 61a extending from the rotation shaft 62 to the −X side. The discharge assisting member 61 rotates. With this, the medium pressing portion 61a is movable below the nipping position Pn of the discharge roller pair 31. Further, the discharge assisting member 61 can press down the medium M being discharged, by the medium pressing portion 61a moving downward.

While the discharge roller pair 31 does not nip the medium M, the medium pressing portion 61a is displaced downward due to the own weight. Specifically, as illustrated in FIG. 18, the medium pressing portion 61a is positioned below the nipping position Pn of the discharge roller pair 31. While the discharge roller pair 31 does not nip the medium M, the position of the medium pressing portion 61a corresponds to the first position. Note that, in the present specification, the position of the medium pressing portion 61a is a position of a part of the medium pressing portion 61a, which actually contacts with the medium M.

The discharge assisting member 61 includes a medium abutting portion 61b at a base end side of the medium pressing portion 61a, in other words, a side thereof close to the rotation shaft 62. In other words, the medium abutting portion 61b is positioned upstream of the medium pressing portion 61a in the transport direction. The medium abutting portion 61b protrudes in a direction containing a +X component and a −Z component with respect to the medium pressing portion 61a. In other words, the medium abutting portion 61b protrudes upstream of the medium pressing portion 61a in the transport direction. In the embodiment, the medium pressing portion 61a and the medium abutting portion 61b are configured to be integrated with each other.

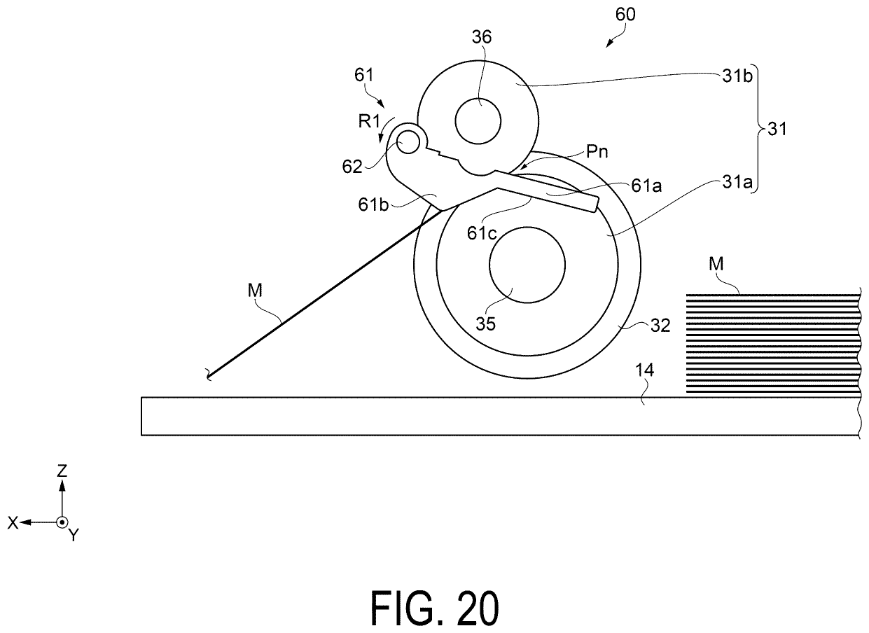

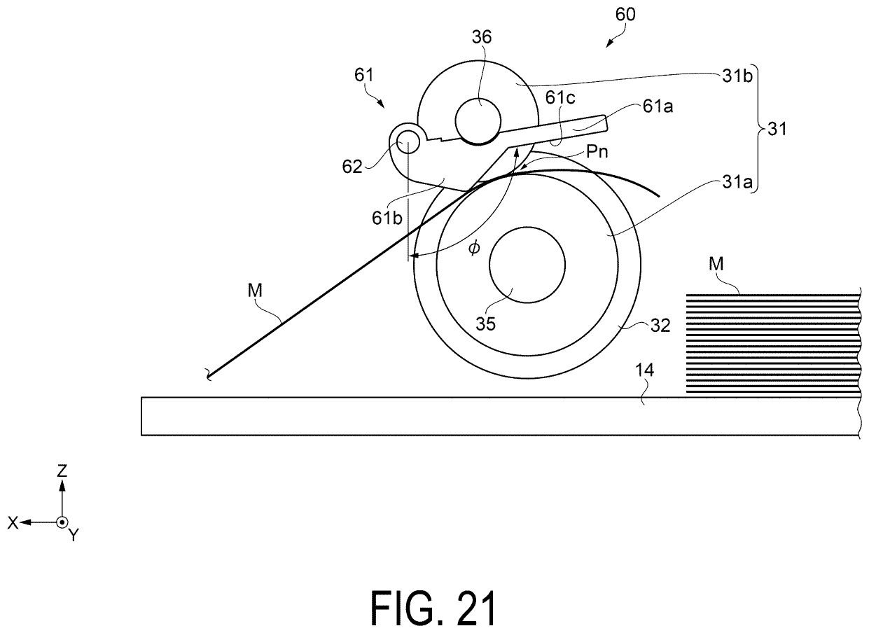

The downstream leading edge of the medium M transported by the medium transport unit 21 abuts against the medium abutting portion 61b in the medium discharge unit 60 (see FIG. 20). In other words, the medium M abuts against the medium abutting portion 61b upstream of the medium pressing portion 61a in the transport direction. After that, when the medium M is further transported, the discharge assisting member 61 is pressed by the medium M to rotate. With this, the medium pressing portion 61a is elevated (see FIG. 21). The position of the medium pressing portion 61a after elevation corresponds to the second position. The second position is a position above the first position. In other words, when the discharge assisting member 61 rotates, the medium pressing portion 61a is movable to the second position above the first position. In the embodiment, the second position is a position above the nipping position Pn of the discharge roller pair 31.

Next, an operation of the medium discharge unit 60 is described.

FIG. 20 to FIG. 22 are side views schematically illustrating a state in which the medium discharge unit 60 of the embodiment discharges the medium M.

As illustrated in FIG. 20, the medium M transported by the medium transport unit 21 abuts against the medium abutting portion 61b of the discharge assisting member 61 upstream of the nipping position Pn of the discharge roller pair 31 in the transport direction, and then the medium abutting portion 61b moves downstream. With this, the discharge assisting member 61 rotates about the rotation shaft 62 in the first direction R1, that is, a counterclockwise direction in FIG. 20.

As illustrated in FIG. 21, as the discharge assisting member 61 rotates in the first direction R1, the medium pressing portion 61a moves upward. Further, the medium abutting portion 61b contacts with the upper surface of the medium M upstream of the nipping position Pn of the discharge roller pair 31 in the discharge direction. Further, while the medium M is transported, the discharge assisting member 61 is in a substantially constant posture where the medium pressing portion 61a moves upward. As described above, the position of the medium pressing portion 61a after elevation due to the medium M being transported corresponds to the second position. In other words, when the downstream leading edge of the medium M in the discharge direction passes through the nipping position Pn, the medium M abuts against the medium abutting portion 61b. With this, the medium pressing portion 61a moves from the first position to the second position. In this manner, when the medium M transported by the medium transport unit 21 abuts against the medium abutting portion 61b, the discharge assisting member 61 rotates about the rotation shaft 62 in the first direction R1. Further, the medium pressing portion 61a moves from the first position to the second position as the discharge assisting member 61 rotates in the first direction R1. Note that, in the embodiment, the medium pressing portion 61a does not contact with the medium M at the second position.

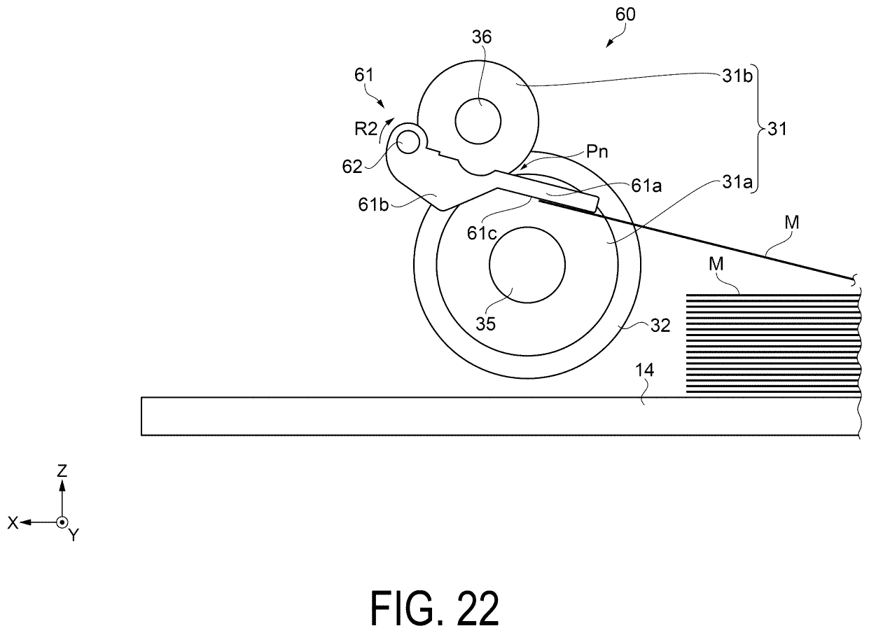

After that, the medium M passes through the nipping position Pn, and the trailing edge of the medium M, in other words, the upstream edge thereof in the discharge direction is separated away from the medium abutting portion 61b. In this state, as illustrated in FIG. 22, the medium pressing portion 61a is lowered due to the own weight. With this, the discharge assisting member 61 rotates about the rotation shaft 62 in the second direction R2 opposite to the first direction R1. As a result, the medium pressing portion 61a presses the medium M downstream of the nipping position Pn in the discharge direction. Specifically, the medium pressing portion 61a presses down the medium M by the own weight, and presses the medium M against the first roller 31a. In this state, the medium M is warped downward between the two first rollers 31a. Thus, the position of the medium pressing portion 61a is below the nipping position Pn of the discharge roller pair 31. Further, the medium pressing portion 61a continues pressing the medium M until the medium M is separated. Note that, in FIG. 22, the part of the medium M that contacts with the circumferential surface of the first roller 31a and the like are omitted in illustration.

After that, the medium M is separated from the medium pressing portion 61a, the position of the medium pressing portion 61a returns to the first position before the medium M is charged. In this manner, when the upstream trailing edge of the medium M in the discharge direction passes through the nipping position Pn, the medium M is separated from the medium abutting portion 61b. With this, the medium pressing portion 61a moves from the second position to the first position. In other words, when the trailing edge of the medium M is separated from the medium abutting portion 61b, the discharge assisting member 61 rotates about the rotation shaft 62 in the second direction R2. Further, the medium pressing portion 61a moves from the second position to the first position as the discharge assisting member 61 rotates in the second direction R2. Further, the medium pressing portion 61a presses down the medium M in the process of moving from the second position to the first position.

Note that, as illustrated in FIG. 18 and FIG. 21, when the medium pressing portion 61a is positioned at the first position (see FIG. 18), a region in which the medium pressing portion 61a and the first roller 31a as viewed in the +Y direction being the axial direction of the first roller 31a is larger than that in a case in which the medium pressing portion 61a is positioned at the second position (see FIG. 21). Further, when the medium pressing portion 61a is positioned at the first position (see FIG. 18), an angle φ of the medium pressing portion 61a with respect to the vertical direction is smaller than that in a case in which the medium pressing portion 61a is positioned at the second position (see FIG. 21). Herein, the angle φ of the medium pressing portion 61a with respect to the vertical direction indicates an angle formed between an abutting surface 61c of the medium pressing portion 61a, which contacts with the medium M, and the vertical direction, and indicates an angle formed between a linear line extending vertically downward from the rotation shaft 62 and the abutting surface 61c.

As described above, according to the medium discharge unit 60 and the image reading apparatus 1 of the embodiment, the following effects can be obtained.

According to the embodiment, when the leading edge of the medium M passes through the nipping position Pn, and the medium abutting portion 61b abuts against the medium M, the medium pressing portion 61a moves upward. With this, the edges of the medium M in the width direction can be prevented from being pressed down. In other words, the entry angle of the downstream edge of the medium M, in other words, the angle of the medium M with respect to the horizontal plane is reduced. As a result, collision between the leading edge of the discharged medium M and the trailing edge of the medium M on the sheet ejection unit 14 is avoided, and hence disorganization of the medium M on the sheet ejection unit 14 is suppressed. In contrast, when the trailing edge of the medium M passes through the nipping position Pn, the medium pressing portion 61a moves downward. With this, the medium M is pressed against the first roller 31a by the medium pressing portion 61a. With this, a force of transporting the medium M downstream is increased. As a result, the medium M moves as the first roller 31a rotates. Thus, the trailing edge of the medium M can be prevented from remaining at the discharge roller pair 31.

Further, according to the embodiment, the medium M transported by the medium transport unit 21 abuts against the medium abutting portion 61b, which enables elevation of the medium pressing portion 61a from the first position to the second position. In other words, according to the embodiment, the medium pressing portion 61a can be elevated with a simple configuration.

Further, according to the embodiment, the discharged medium M is separated from the medium abutting portion 61b, which enables the medium pressing portion 61a to be lowered from the second position to the first position. In other words, according to the embodiment, the medium pressing portion 61a can be lowered with a simple configuration.

Further, according to the embodiment, when the medium pressing portion 61a is positioned at the first position, a region in which the medium pressing portion 61a and the first roller 31a overlap with each other is larger than that in a case in which the medium pressing portion 61a is positioned at the second position. In other words, when the medium pressing portion 61a is positioned at the first position, the medium M is pressed against the first roller 31a. Thus, the trailing edge of the medium M can be prevented from remaining at the discharge roller pair 31. In contrast, when the medium pressing portion 61a is positioned at the second position, a region in which the medium pressing portion 61a and the first roller 31a overlap with each other is smaller than that in a case in which the medium pressing portion 61a is positioned at the first position. Thus, at the leading edge of the medium M, the edges thereof in the width direction can be prevented from being pressed down.

Further, according to the embodiment, when the medium pressing portion 61a is positioned at the first position, the angle of the medium pressing portion 61a with respect to the vertical direction is smaller than that in a case in which the medium pressing portion 61a is positioned at the second position. In other words, when the medium pressing portion 61a is positioned at the first position, the medium M is pressed against the first roller 31a. Thus, the trailing edge of the medium M can be prevented from remaining at the discharge roller pair 31. In contrast, when the medium pressing portion 61a is positioned at the second position, the angle of the medium pressing portion 61a with respect to the vertical direction is larger than that in a case in which the medium pressing portion 61a is positioned at the first position. Thus, at the leading edge of the medium M, the edges thereof in the width direction can be prevented from being pressed down.

Further, according to the embodiment, the medium pressing portion 61a presses the medium M downstream of the nipping position Pn in the discharge direction. Thus, the trailing edge of the medium M can effectively be prevented from remaining at the discharge roller pair 31.

Further, according to the embodiment, the medium pressing portion 61a does not contact with the medium M at the second position. With this, the medium M can further be prevented from being pressed down.

Further, according to the embodiment, the plurality of discharge assisting members 61 are arrayed along the axial direction of the first roller 31a. Thus, the medium M having various sizes can effectively be pressed by the discharge assisting member 61.

Further, according to the embodiment, the medium M is scraped from the discharge roller pair 31 by the scraping member 32. Thus, the trailing edge of the medium M can further be prevented from remaining at the discharge roller pair 31.

### 5. Fifth Embodiment

Next, the image reading apparatus 1 according to a fifth embodiment is described.

The image reading apparatus 1 of the embodiment includes a medium discharge unit 60A different from the medium discharge unit 60 of the fourth embodiment. The configurations other than the medium discharge unit 60 are similar to those in the fourth embodiment, and hence description thereof is omitted.

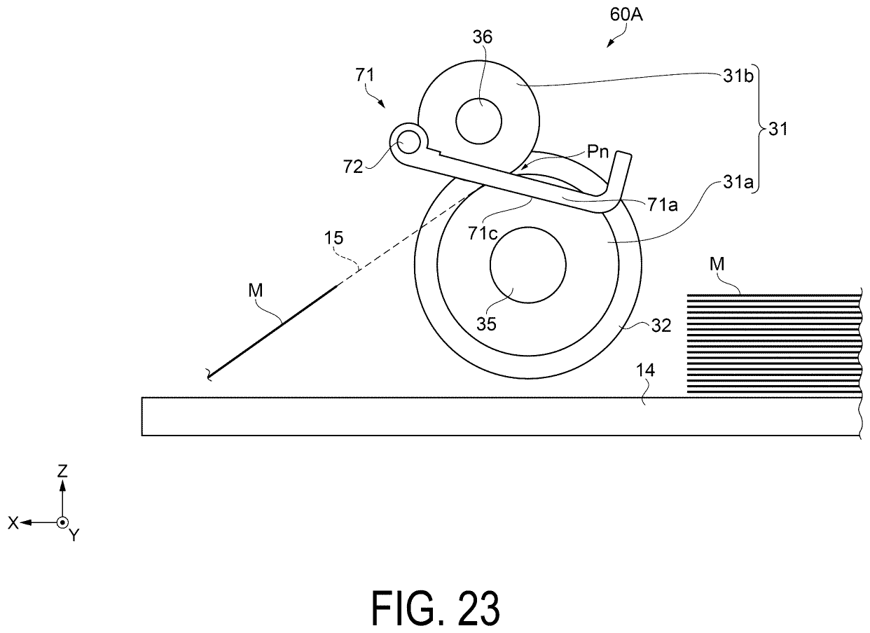

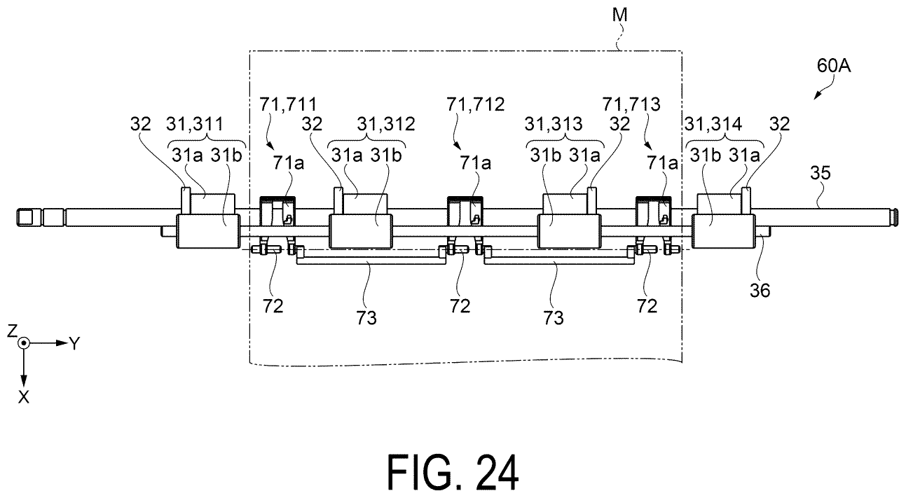

FIG. 23 is a side view schematically illustrating the medium discharge unit 60A of the embodiment, and FIG. 24 is a plan view illustrating the medium discharge unit 60A.

As illustrated in FIG. 23, the medium discharge unit 60A of the embodiment includes a third pressing member 71 in place of the discharge assisting member 61 in the fourth embodiment.

The third pressing member 71 includes a medium pressing portion 71a extending from a rotation shaft 72 to the −X side. The third pressing member 71 rotates. With this, the medium pressing portion 71a is movable below the nipping position Pn of the discharge roller pair 31. Further, the medium pressing portion 71a moves downward. With this, the third pressing member 71 presses down the medium M discharged from the discharge roller pair 31.

While the discharge roller pair 31 does not nip the medium M, the medium pressing portion 71a is displaced downward due to the own weight. Specifically, as illustrated in FIG. 23, the medium pressing portion 71a is positioned below the nipping position Pn of the discharge roller pair 31. In this state, the medium pressing portion 71a extends in a direction containing a −X component and a −Z component, and intersects with the transport path 15. While the discharge roller pair 31 does not nip the medium M, the position of the medium pressing portion 71a corresponds to the first position. Note that, in the present specification, the position of the medium pressing portion 71a is a position of a part of the medium pressing portion 71a, which actually contacts with the medium M.

As illustrated in FIG. 24, the medium discharge unit 60A includes the plurality of third pressing members 71. The plurality of third pressing members 71 are arrayed along the ±Y direction being the axial direction of the first roller 31a. In the embodiment, the medium discharge unit 60A includes the three third pressing members 71. The third pressing members 71 are arranged, with one placed between each of the four discharge roller pairs 31. Each of the third pressing members 71 can rotate about the rotation shaft 72 positioned on the commonly-shared imaginary linear line. The rotation shaft 72 of the third pressing member 71 is arranged on the +X side, in other words, upstream of the rotation shaft 35 of the first roller 31a and the rotation shaft 36 of the second roller 31b in the discharge direction. For example, the rotation shaft 72 is supported rotatably by the casing of the upper unit 12 or other structural bodies. The rotation shaft 72 is an example of the fourth rotation shaft. In the embodiment, the three third pressing members 71 are coupled to each other by two coupling members 73 extending in the ±Y direction. Specifically, the three third pressing members 71 are formed integrally with the two coupling members 73. Thus, the three third pressing members 71 rotate interlockingly with each other.

In the embodiment, the four discharge roller pairs 31 are referred to as discharge roller pairs 311, 312, 313, and 314 sequentially from the −Y side, and the three third pressing members 71 are referred to as third pressing members 711, 712, and 713 sequentially from the −Y side. In this case, the third pressing member 712 at the center is arranged between the two discharge roller pairs 312 and 313 that are adjacent to each other at the center. Further, the third pressing member 711 on the −Y side and the third pressing member 713 on the +Y side are arranged on the outer sides of the two discharge roller pairs 312 and 313 that are adjacent to each other at the center. The third pressing member 712 at the center corresponds to an inner pressing member, and the third pressing member 711 on the −Y side and the third pressing member 713 on the +Y side correspond to outer pressing members.

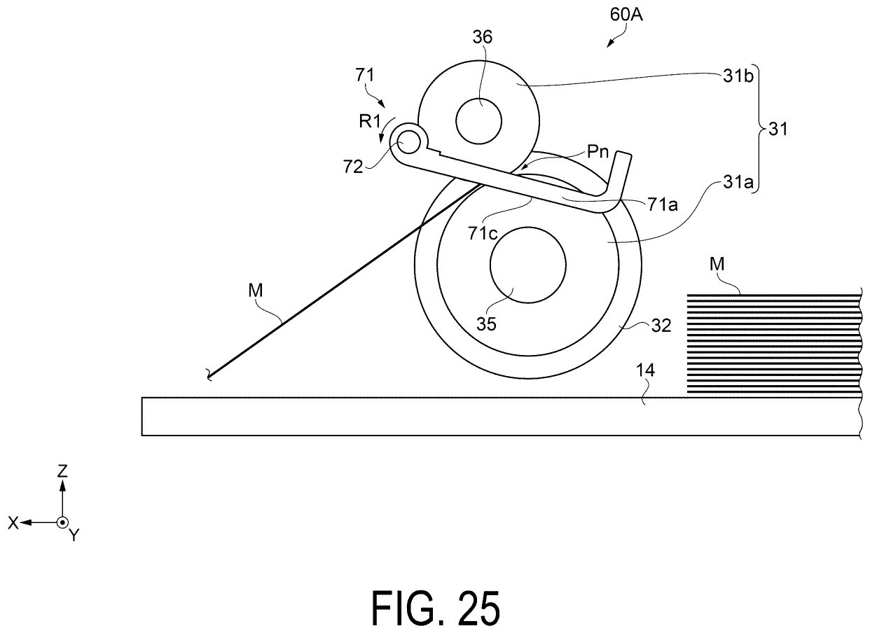

FIG. 25 to FIG. 27 are side views schematically illustrating a state in which the medium discharge unit 60A of the embodiment discharges the medium M.

As illustrated in FIG. 25, the medium M transported by the medium transport unit 21 abuts against the medium pressing portion 71a of the third pressing member 71 in the vicinity of the nipping position Pn of the discharge roller pair 31, and then the medium pressing portion 71a moves downstream. With this, the third pressing member 71 rotates about the rotation shaft 72 in the first direction R1, that is, a counterclockwise direction in FIG. 25.

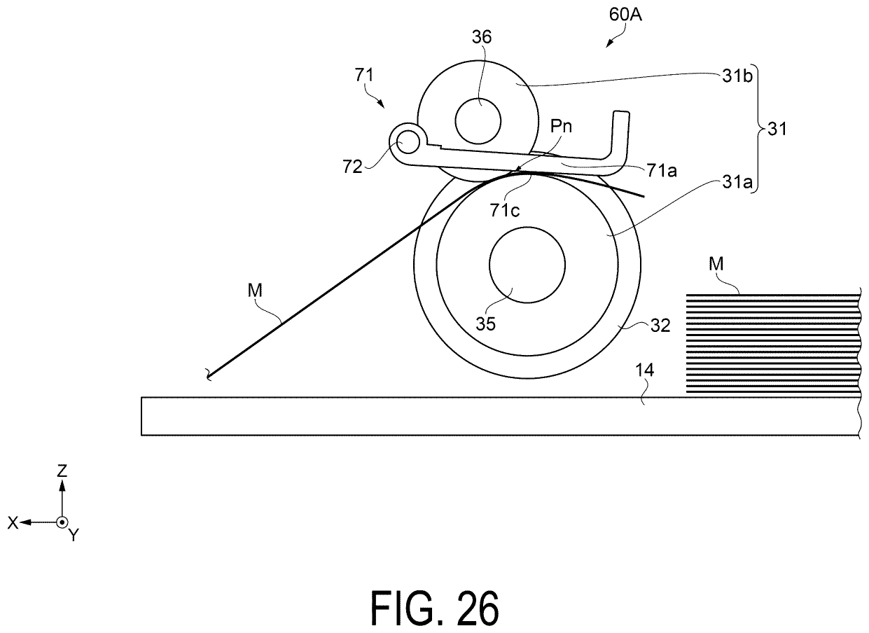

As illustrated in FIG. 26, as the third pressing member 71 rotates in the first direction R1, the medium pressing portion 71a moves upward. In this state, the medium pressing portion 71a extends along the discharge direction, and an abutting surface 71c facing the medium M contacts with the upper surface of the medium M. Further, while the medium M is transported, the third pressing member 71 is in a substantially constant posture where the medium pressing portion 71a moves upward. The position of the medium pressing portion 71a after elevation due to the medium M being transported corresponds to the second position.

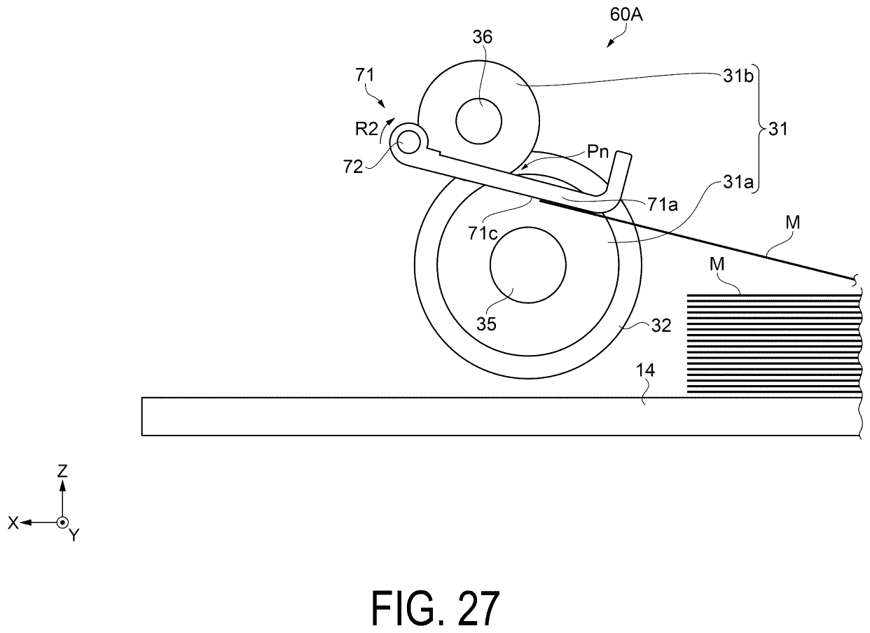

Further, as illustrated in FIG. 27, when the medium M is further discharged, and the trailing edge of the medium M passes through the nipping position Pn of the discharge roller pair 31, the medium pressing portion 71a is lowered due to the own weight. With this, the third pressing member 71 rotates about the rotation shaft 72 in the second direction R2 opposite to the first direction R1. As a result, the medium pressing portion 71a presses the medium M downstream of the nipping position Pn in the discharge direction. Specifically, the medium pressing portion 71a presses down the medium M by the own weight, and presses the medium M against the first roller 31a. In this state, the medium M is warped downward between the two first rollers 31a. Thus, the position of the medium pressing portion 71a is below the nipping position Pn of the discharge roller pair 31. Further, the medium pressing portion 71a continues pressing the medium M until the medium M is separated. Note that, in FIG. 27, the part of the medium M that contacts with the circumferential surface of the first roller 31a and the like are also omitted in illustration.

After that, the medium M is separated from the medium pressing portion 71a, the position of the medium pressing portion 71a returns to the first position before the medium M is charged. In this manner, when the upstream trailing edge of the medium M in the discharge direction passes through the nipping position Pn, the medium pressing portion 71a moves from the second position to the first position. In other words, when the trailing edge of the medium M is separated from the nipping position Pn, the third pressing member 71 rotates about the rotation shaft 72 in the second direction R2. Further, the medium pressing portion 71a moves from the second position to the first position as the third pressing member 71 rotates in the second direction R2. Further, the medium pressing portion 71a presses down the medium M in the process of moving from the second position to the first position.

Herein, as illustrated in FIG. 24, it is assumed that one edge of the medium M in the width direction, in other words, the +Y direction is positioned between the discharge roller pair 311 and the discharge roller pair 312 and the other edge of the medium M in the width direction is positioned between the discharge roller pair 313 and the discharge roller pair 314. In this case, while the medium M is nipped by the discharge roller pair 31, the center part of the medium M in the width direction is not significantly warped even when being pressed by the third pressing member 712 at the center. This is because both the sides of the medium M are supported by the two adjacent discharge roller pairs 312 and 313. In other words, the third pressing member 712 at the center is in a state in which rotation thereof is suppressed. In contrast, the edges of the medium M in the width direction may significantly be warped downward by the third pressing member 71 since one side is not supported by the discharge roller pair 31.

However, in the embodiment, the three third pressing members 71 are coupled to each other, and rotate interlockingly with each other. In other words, the rotation angles of the three third pressing members 71 are substantially the same at all times. Thus, rotation of the third pressing member 712 at the center is suppressed, and hence rotation of the two outer third pressing members 711 and 713 is also suppressed. In other words, the edge of the medium M in the width direction are not excessively pressed down by the two outer third pressing members 711 and 713. In this manner, in the embodiment, the plurality of third pressing members 71 rotate interlockingly with each other. With this, the edges of the medium M in the width direction can be prevented from being pressed down.

As described above, according to the medium discharge unit 60A and the image reading apparatus 1 of the embodiment, the following effects can be obtained.

According to the embodiment, the discharged medium M is pressed against the first roller 31a by the third pressing member 71. Thus, a force of transporting the medium M downstream is increased. As a result, the medium M moves as the first roller 31a rotates. Thus, the trailing edge of the medium M can be prevented from remaining at the discharge roller pair 31. Further, according to the embodiment, the third pressing member 712 arranged between the two adjacent discharge roller pairs 312 and 313 and the two third pressing members 711 and 713 arranged on the outer sides of the two discharge roller pairs 312 and 313 rotate interlockingly with each other. Thus, for the reason described above, even when the outer third pressing members 711 and 713 face the edges of the medium M in the width direction, the edges of the medium M are prevented from being pressed down. In other words, the entry angle of the downstream edge of the medium M, in other words, the angle of the medium M with respect to the horizontal plane is reduced. As a result, collision between the leading edge of the discharged medium M and the trailing edge of the medium M on the sheet ejection unit 14 is avoided, and hence disorganization of the medium M on the sheet ejection unit 14 is suppressed.

### 6. Modification Examples

The embodiment is based on the configuration described above, and partial modifications, omissions, and the like may be made to the configuration without departing from the gist of the present disclosure. Further, the embodiment and modification examples described below can be combined with each other as long as no technical contradiction arises due to the combination. The modification examples are described below.

The respective embodiments described above illustrate a configuration in which the first pressing member 33, 41, the second pressing member 40, the third pressing member 71, and the discharge assisting member 61 press the medium M by the own weights, but the configuration is not limited thereto. For example, those members may be configured to press the medium M while receiving a biasing force from a biasing means such as a spring. Further, those members may be configured by elastic members such as a plate spring, and may be configured to press the medium M by the own elastic force.

The first and second embodiments described above illustrate a configuration in which the medium pressing portion 33a contacts with the medium M while being lifted up by the lifting member 34. However, the medium pressing portion 33a in a lifted state may not contact with the medium M. In other words, the second position of the medium pressing portion 33a may be above the nipping position Pn of the discharge roller pair 31. Further, the second position of the medium pressing portion 33a may be below the nipping position Pn of the discharge roller pair 31.

The fourth embodiment described above illustrates a configuration in which the medium pressing portion 61a does not contact with the medium M at the second position. However, the medium pressing portion 61a may contact with the medium M at the second position as long as the medium M is not excessively pressed.

The fourth embodiment described above illustrates a configuration in which all the discharge assisting members 61 include the medium abutting portions 61b, but the configuration is not limited thereto. For example, among the three discharge assisting members 61, only the two outside discharge assisting members 61, which are highly likely to contact with the edges of the medium M in the width direction, may be provided with the medium abutting portion 61b, and the discharge assisting member 61 at the center may not be provided with the medium abutting portion 61b. In this case, the discharge assisting member 61 at the center may be configured similarly to the third pressing member 71 in the fifth embodiment.

In the respective embodiments described above, the numbers of the discharge roller pairs 31, the scraping members 32, the first pressing members 33, the second pressing members 40, the third pressing members 71, and the discharge assisting members 61 are not limited to the numbers described above. The numbers of the respective components may be less than the numbers described above, or may be more than the numbers described above. Further, in the first and second embodiments described above, the number of the medium contacting portion 34a of the lifting member 34 is not limited to one, and the plurality of the medium contacting portions 34a may be provided.

The first and second embodiments described above illustrate a configuration in which the lifting member 34 lifts up all the three medium pressing portions 33b, but the configuration is not limited thereto. For example, among the three medium pressing portions 33b, only the two outer medium pressing portions 33b, which are highly likely to contact with the edges of the medium M in the width direction, may be lifted, and the medium pressing portion 33a at the center may not be lifted.

The first to third embodiments described above illustrate a configuration in which the plurality of first pressing members 33, 41 that are separated from each other are arranged between the discharge roller pairs 31, but the configuration is not limited thereto. For example, the first pressing members 33 and 41 may be configured so that the three medium pressing portions 33b are coupled to one rotation shaft extending in the ±Y direction. In this case, in the first and second embodiments described above, the number of the lever portions 33b extending to the +X side may be one.

Further, the fourth embodiment described above illustrates a configuration in which the plurality of discharge assisting members 61 that are separated from each other are arranged between the discharge roller pairs 31, but the configuration is not limited thereto. For example, similarly to the fifth embodiment, there may be adopted a configuration in which the plurality of discharge assisting members 61 are coupled to each other to rotate interlockingly with each other.

The second and third embodiments illustrate a configuration in which the second pressing member 40 rotates about the rotation shaft 36 of the second roller 31b. However, the second pressing member 40 may be configured to rotate about a rotation shaft different from the rotation shaft 36.

The respective embodiments described above illustrate a configuration in which the image reading apparatus 1 includes the two sensor units, namely, the first sensor unit 24 and the second sensor unit 25. However, the number of sensor units is not limited to two, and may be one, three, or more.

The medium discharge units 30, 30A, 30B, 60, and 60A of the respective embodiments described above are not limited to the configuration in which the medium discharge units are provided to the image reading apparatus 1, and may be provided to other electronic apparatuses. For example, the medium discharge units 30, 30A, 30B, 60, and 60A may be provided to an image recording apparatus that records an image on the medium M being transported.

What is claimed is:

1. A medium discharge device configured to discharge a medium to a placement unit on which the medium is placed, the medium discharge device comprising:
a roller pair including a first roller and a second roller positioned above the first roller and being configured to nip the medium between the first roller and the second roller and discharge the medium to the placement unit;
a first pressing member including a first member and being configured to press the medium by the first member, the first member being configured to move below a nipping position at which the roller pair nips the medium; and
a lifting member configured to lift up the first member from a first position below the nipping position to a second position above the first position, wherein
the first member is lifted up by the lifting member while a downstream leading edge of the medium in a discharge direction passes through the nipping position, and moves from the first position to the second position, and
while an upstream trailing edge of the medium in the discharge direction passes through the nipping position, the first member moves from the second position to the first position.

2. A medium discharge device according to claim 1, comprising:
a transport unit configured to transport the medium toward the roller pair, wherein
the first pressing member is a member configured to rotate about a first rotation shaft, and includes the first member and a second member that contacts the lifting member,
the lifting member is configured to rotate about a second rotation shaft arranged upstream of the first rotation shaft in the discharge direction, and includes a third member that contacts the medium and a fourth member that contacts the second member,
when the medium transported by the transport unit contacts the third member upstream of the nipping position in the discharge direction, the lifting member rotates about the second rotation shaft in a first direction, the second rotation shaft,
when the lifting member rotates the first direction, and the fourth member presses the second member, the first pressing member rotates about the first rotation shaft in the first direction, and
when the first pressing member rotates in the first direction, the first member moves from the first position to the second position.

3. A medium discharge device according to claim 2, wherein
when the trailing edge of the medium is separated from the lifting member, and the lifting member rotates about the second rotation shaft in a second direction opposite to the first direction, the fourth member is separated from the second member, and
when the fourth member is separated from the second member, and the first pressing member rotates about the first rotation shaft in the second direction, the first member moves from the second position to the first position.

4. A medium discharge device according to claim 2, wherein
when the first member is positioned at the first position, a region in which the first member and the first roller overlap with each other as viewed in an axial direction of the first roller is larger than that in a case in which the first member is at the second position.

5. A medium discharge device according to claim 2, wherein
when the first member is positioned at the first position, an angle of the first member with respect to a horizontal plane is larger than that in a case in which the first member is positioned at the second position.

6. A medium discharge device according to claim 1, comprising
a plurality of the first pressing members arrayed along an axial direction of the first roller.

7. A medium discharge device according to claim 1, comprising
a scraping member being configured by an elastic member rotating coaxially with the first roller and being configured to nip the medium with the second roller.

8. A medium discharge device according to claim 1, comprising
a second pressing member configured to press, toward the placement unit, the medium discharged from the roller pair on the placement unit positioned in the discharge direction with respect to the first member of the first pressing member.

9. A medium discharge device configured to discharge a medium to a placement unit on which the medium is placed, the medium discharge device comprising:
a roller pair including a first roller and a second roller positioned above the first roller and being configured to nip the medium between the first roller and the second roller and discharge the medium to the placement unit; and
a discharge assisting member configured to assist a discharge operation of the medium to be discharged from the roller pair, wherein
the discharge assisting member includes:
a medium pressing portion configured to move between a first position below a nipping position at which the roller pair nips the medium and a second position above the first position and press down the medium in the process of moving from the second position to the first position; and
a medium abutting portion against which the medium abuts upstream of the medium pressing portion in the discharge direction of the medium,
when the medium abuts against the medium abutting portion while a downstream leading edge of the medium in the discharge direction passes through the nipping position, the medium pressing portion moves from the first position to the second position, and
when the medium abutting portion is separated from the medium while an upstream trailing edge of the medium in the discharge direction passes through the nipping position, the medium pressing portion moves from the second position to the first position.

10. A medium discharge device according to claim 9, comprising
a transport unit configured to transport the medium toward the roller pair, wherein
the discharge assisting member is a member configured to rotate about a third rotation shaft,
when the medium transported by the transport unit abuts against the medium abutting portion, the discharge assisting member rotates about the third rotation shaft in a first direction, and
the medium pressing portion moves from the first position to the second position as the discharge assisting member rotates in the first direction.

11. A medium discharge device according to claim 10, wherein
when the trailing edge of the medium is away from the medium abutting portion, the discharge assisting member rotates about the third rotation shaft in a second direction opposite to the first direction, and
the medium pressing portion moves from the second position to the first position as the discharge assisting member rotates in the second direction.

12. A medium discharge device according to claim 10, wherein
when the medium pressing portion is positioned at the first position, a region in which the medium pressing portion and the first roller overlap with each other as viewed in an axial direction of the first roller is larger than that in a case in which the medium pressing portion is positioned at the second position.

13. A medium discharge device according to claim 10, wherein
when the medium pressing portion is positioned at the first position, an angle of the medium pressing portion with respect to a vertical direction is smaller than that in a case in which the medium pressing portion is positioned at the second position.

14. A medium discharge device according to claim 10, wherein
the medium pressing portion presses the medium downstream of the nipping position in the discharge direction.

15. A medium discharge device according to claim 10, wherein
the medium pressing portion at the second position does not contact the medium.

16. A medium discharge device according to claim 9, comprising
a plurality of the discharge assisting members arrayed along an axial direction of the first roller.

17. A medium discharge device according to claim 9, comprising
a scraping member being configured by an elastic member rotating coaxially with the first roller and being configured to nip the medium with the second roller.

18. An electronic apparatus comprising:
the medium discharge device according to claim 1.
